(19) United States
(12) Patent Application Publication
(10) Pub. No.: US 2026/0370656 A1
(43) Pub. Date: Nov. 19, 2026

(54) METHOD AND DEVICE FOR INDICATING CAPABILITY OF TERMINAL

(71) Applicant: Beijing Xiaomi Mobile Software Co., Ltd., Beijing (CN)

(72) Inventors: Haoran LIANG, Beijing (CN); Wei LU, Beijing (CN)

(21) Appl. No.: 19/103,143

(22) PCT Filed: Aug. 12, 2022
(86) PCT No.: PCT/CN2022/112334

§ 371 Date: Feb. 11, 2025

(51) Int. Cl. H04L 9/40

(52) U.S. Cl. CPC H04L 63/1433

(57) ABSTRACT

A method for indicating a capability of a terminal, the method including: receiving a capability request message sent by a first core network device through a visited network; and according to the capability request message, sending first information to the first core network device through the visited network, where the first information includes first indication information and an integrity check code, and the first indication information is configured to indicate the capability of the terminal.

### CROSS-REFERENCE

The present application is a U.S. National Stage of International Application No. PCT/CN2022/112334, filed on Aug. 12, 2022, the contents of all of which are incorporated herein by reference in their entireties for all purposes.

### BACKGROUND OF THE INVENTION

As specified in the technical specification (TS) 22.261 of the 3rd generation partnership project (3GPP), a home public land mobile network (HPLMN) should be able to provide a user equipment (UE) with prioritization information of a visited public land mobile network (VPLMN) with which the UE may register for a network slice, to support a roaming UE activating network slice services.

### SUMMARY OF THE INVENTION

The present disclosure relates to the technical field of communication, and in particular to a method and device for indicating a capability of a terminal.

A method for indicating a capability of a terminal is provided in embodiments of a first aspect of the present disclosure. The method is performed by the terminal, and the method includes:
receiving a capability request message sent by a first core network device through a visited network; and sending at least one piece of first information or an identifier of the terminal to the first core network device through the visited network according to the capability request message; where the first information includes first indication information and an integrity check code, and the first indication information is configured to indicate the capability of the terminal.

A method for indicating a capability of a terminal is provided in the embodiments of a second aspect of the present disclosure. The method is performed by a first core network device, and the method includes:
sending a capability request message to the terminal through a visited network, where the capability request message is configured to request the terminal to indicate the capability of the terminal; and receiving at least one piece of first information or an identifier of the terminal sent by the terminal through the visited network; where the first information includes first indication information and an integrity check code, and the first indication information is configured to indicate the capability of the terminal.

A method for indicating a capability of a terminal is provided in the embodiments of a third aspect of the present disclosure. The method is performed by a second core network device, and the method includes:
receiving at least one piece of first information or an identifier of the terminal sent by a first core network device; where the first information includes first indication information and an integrity check code, and the first indication information is configured to indicate the capability of the terminal.

A communication device is provided in the embodiments of a fourth aspect of the present disclosure. The communication device includes one or more processors and a memory that stores a computer program; where the computer program, when collectively executed by the one or more processors, causes the communication device to perform the method for indicating the capability of the terminal in the embodiment of the first aspect.

Some additional aspects and advantages of the present disclosure will be set forth in the following description, and some additional aspects and advantages will be apparent from the following description or learned by practice of the present disclosure.

### BRIEF DESCRIPTION OF DRAWINGS

In order to describe the technical solutions in embodiments of the present disclosure or in the background art more clearly, the accompanying drawings required to be used in the embodiments of the present disclosure or the background art will be described below.

FIG. 1 is a schematic diagram of an architecture of a communication system according to an embodiment of the present disclosure;

FIG. 2 is a schematic flowchart of a method for indicating a capability of a terminal according to an embodiment of the present disclosure;

FIG. 3 is a schematic flowchart of a method for indicating the capability of the terminal according to an embodiment of the present disclosure;

FIG. 4 is a schematic flowchart of a method for indicating the capability of the terminal according to an embodiment of the present disclosure;

FIG. 5 is a schematic flowchart of a method for indicating the capability of the terminal according to an embodiment of the present disclosure;

FIG. 6 is a schematic flowchart of a method for indicating the capability of the terminal according to an embodiment of the present disclosure;

FIG. 7 is a schematic flowchart of a method for indicating the capability of the terminal according to an embodiment of the present disclosure;

FIG. 8 is a schematic flowchart of a method for indicating the capability of the terminal according to an embodiment of the present disclosure;

FIG. 9 is a schematic flowchart of a method for indicating the capability of the terminal according to an embodiment of the present disclosure;

FIG. 10 is a schematic flowchart of a method for indicating the capability of the terminal according to an embodiment of the present disclosure;

FIG. 11 is a schematic flowchart of a method for indicating the capability of the terminal according to an embodiment of the present disclosure;

FIG. 12 is a schematic flowchart of a method for indicating the capability of the terminal according to an embodiment of the present disclosure;

FIG. 13 is a schematic flowchart of a method for indicating the capability of the terminal according to an embodiment of the present disclosure;

FIG. 14 is a schematic flowchart of a method for indicating the capability of the terminal according to an embodiment of the present disclosure;

FIG. 15 is a schematic structural diagram of a device for indicating the capability of the terminal according to an embodiment of the present disclosure;

FIG. 16 is a schematic structural diagram of a device for indicating the capability of the terminal according to an embodiment of the present disclosure;

FIG. 17 is a schematic structural diagram of a device for indicating the capability of the terminal according to an embodiment of the present disclosure;

FIG. 18 is a schematic diagram of a communication system according to an embodiment of the present disclosure;

FIG. 19 is a schematic structural diagram of a device for indicating the capability of the terminal according to another embodiment of the present disclosure; and

FIG. 20 is a schematic structural diagram of a chip according to an embodiment of the present disclosure.

### DETAILED DESCRIPTION OF THE INVENTION

Examples will be described in detail here, and illustratively shown in the accompanying drawings. When the following description relates to the accompanying drawings, the same numbers in different accompanying drawings denote the same or similar elements, unless indicated otherwise. Implementations described in the following examples do not denote all embodiments consistent with the embodiments of the present disclosure. On the contrary, the implementations are merely instances of a device and method consistent with some aspects of the embodiments of the present disclosure as recited in the appended claims.

The terms used in the embodiments of the present disclosure are merely to describe specific embodiments, instead of limiting the embodiments of the present disclosure. The singular forms “a”, “an”, and “the” used in the embodiments and the appended claims of the present disclosure are also intended to include the plural forms, unless clearly stated in the context otherwise. It should also be understood that the term “and/or” used here indicates and encompasses one or any or all possible combinations of a plurality of associated items listed.

It should be understood that the terms first, second, third, etc. may be employed in the embodiments of the present disclosure to describe various information, but should not limit these information. These terms are merely used to distinguish between the same type of information. For example, first information can also be referred to as second information, and similarly, second information can also be referred to as first information, without departing from the scope of the embodiments of the present disclosure. Depending on the context, the word “if” as used here can be interpreted as “at the time of . . . ”, “when . . . ”, or “in response to determining”.

The embodiments of the present disclosure are described in detail below, and illustratively shown in the accompanying drawings. The same or similar reference numerals denote the same or similar elements throughout. The embodiments described with reference to the accompanying drawings below are illustrative, and are intended to explain the present disclosure, but cannot be interpreted as limiting the present disclosure.

As specified in the technical specification (TS) 22.261 of the 3rd generation partnership project (3GPP), a home public land mobile network (HPLMN) should be able to provide a user equipment (UE) with prioritization information of a visited public land mobile network (VPLMN) with which the UE may register for a network slice, to support a roaming UE activating network slice services.

Specifically, according to the technical report (TR) 23.700-41 of the 3GPP, before a home public network triggers UE parameter update (UPU) or steering of roaming (SoR) procedure, the UE may need to indicate a UPU capability or a SoR capability to the home network. However, capability indication information may be tampered or removed by the VPLMN.

In order to better understand a method for indicating a capability of a terminal disclosed in the embodiments of the present disclosure, a communication system applicable to the embodiments of the present disclosure is first described below.

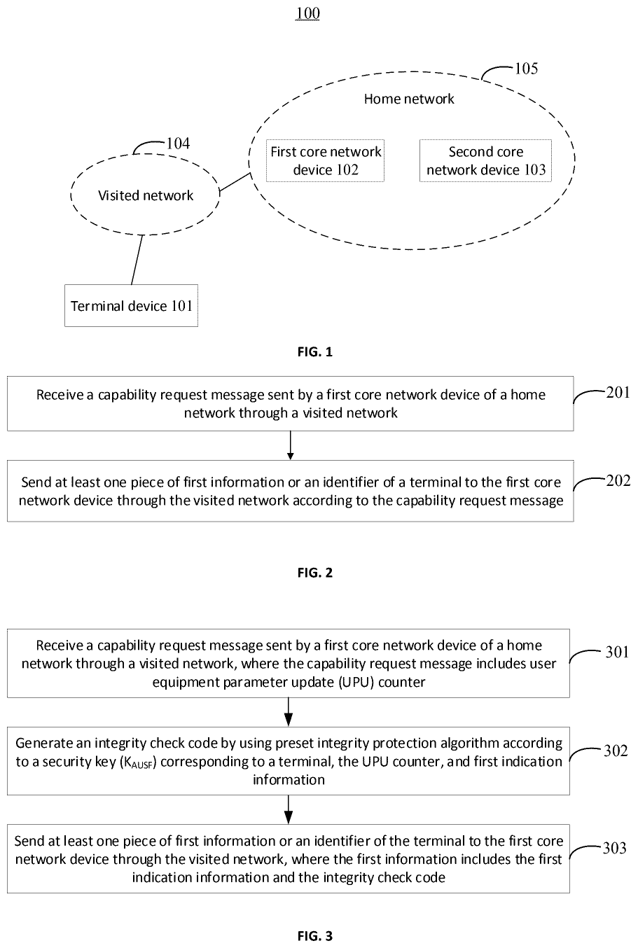

With reference to FIG. 1, FIG. 1 is a schematic diagram of an architecture of a communication system 100 according to an embodiment of the present disclosure. The communication system 100 can include, but is not limited to, one terminal and one core network device. Numbers and forms of the devices shown in FIG. 1 are merely illustrative, and do not limit the embodiment of the present disclosure. In practical application, two or more network devices and two or more terminals can be included. The communication system 100 shown in FIG. 1 includes a terminal 101, a first core network device 102, and a second core network device 103 as an example.

It should be noted that the technical solution in the embodiment of the present disclosure can be applied to various communication systems. For example, the technical solution can be applied to a long term evolution (LTE) system, a 5th generation (5G) of mobile communication system, a 5G of new radio (NR) system, other future novel mobile communication systems, etc.

The terminal 101 in the embodiment of the present disclosure is an entity positioned on a user side and configured to receive or send a signal, such as a mobile phone. The terminal can also be referred to as a terminal, user equipment (UE), a mobile station (MS), a mobile terminal (MT), etc. The terminal can be a vehicle, smart vehicle, mobile phone, wearable device, and pad having a function of communication; and a computer, virtual reality (VR) terminal, augmented reality (AR) terminal, radio terminal in industrial control, radio terminal in self-driving, radio terminal in remote medical surgery, radio terminal in smart grid, radio terminal in transportation safety, radio terminal in smart city, and radio terminal in smart home having a function of radio transceiving, etc. The specific technology and the specific device form employed by the terminal are not limited in the embodiment of the present disclosure.

The home network may be the home public land mobile network (HPLMN). In the embodiment of the present disclosure, the first core network device 102 and the second core network device 103 are core network devices in a home network 105. The first core network device 102 may be unified data management (UDM), and the second core network device may be an authentication server function (AUSF). It can be understood that the home network 105 may further include other core network devices, such as a steering of roaming application function (SoR AF).

The visited network may be the visited public land mobile network (VPLMN). In the embodiment of the present disclosure, the terminal 101 may not be under the coverage of the home network 105, and the terminal 101 may interact with the home network 105 through a visited network 104. It can be understood that the visited network 104 may also include at least one core network device, such as an access and mobility management function (AMF), a user plane function (UPF), and a session management function (SMF).

As specified in the technical specification (TS) 22.261 of the 3rd generation partnership project (3GPP), the home public land mobile network (HPLMN) should be able to provide the user equipment (UE) with prioritization information of the visited public land mobile network (VPLMN) with which the UE may register for a network slice, to support a roaming UE activating network slice services.

Specifically, according to the technical report (TR) 23.700-41 of the 3GPP, before a home network triggers UE parameter update (UPU) or steering of roaming (SoR) procedure, the UE may need to indicate a UPU capability or a SoR capability to the home network. However, capability indication information may be tampered or removed by the VPLMN. Thus, it is required to design a security mechanism, so that the terminal can securely indicate its own UPU capability or SoR capability to the core network device in the home network.

It can be understood that in each embodiment of the present disclosure, information interaction between the terminal and each core network device is completed through transparent transmission of an access network device.

It can be understood that the communication system described in the embodiment of the present disclosure is intended to describe the technical solution according to the embodiment of the present disclosure more clearly, instead of limiting the technical solution according to the embodiment of the present disclosure. As those of ordinary skill in the art know, with evolution of the system architecture and emergence of new service scenario, the technical solution according to the embodiment of the present disclosure is also applicable to solve similar technical problems.

The method and device for indicating a capability of a terminal provided by the present disclosure are described in detail below with reference to the accompanying drawings.

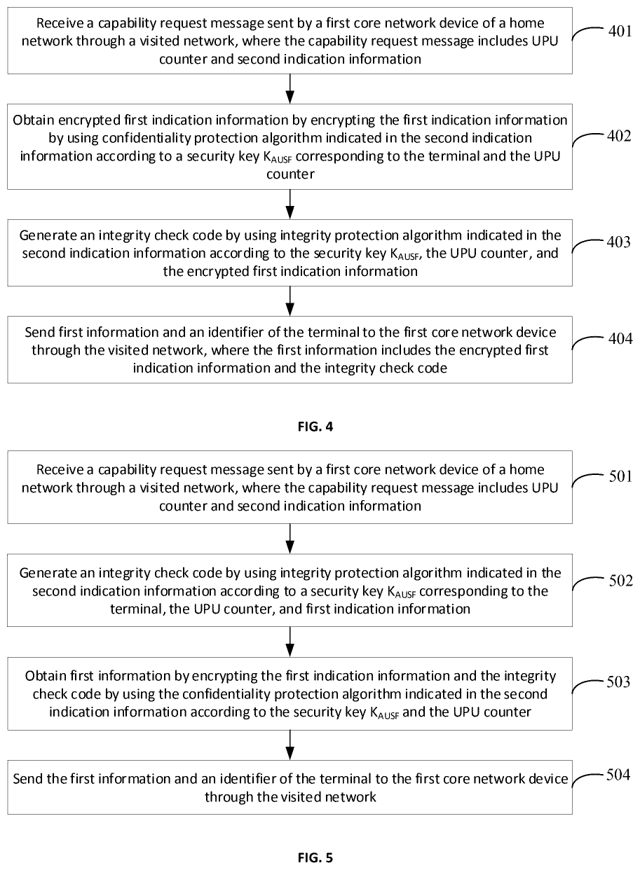

With reference to FIG. 2, FIG. 2 is a schematic flowchart of a method for indicating the capability of the terminal according to an embodiment of the present disclosure. It should be noted that the method for indicating the capability of the terminal according to the embodiment of the present disclosure is performed by the terminal. The method may be performed alone or in conjunction with any one of the other embodiments of the present disclosure. As shown in FIG. 2, the method may include:

Step 201: a capability request message sent by a first core network device through a visited network is received.

In the embodiment of the present disclosure, the terminal may receive the capability request message sent by the first core network device through the visited network, where the capability request message is configured to request the terminal to indicate the capability of the terminal to the first core network device.

In the embodiment of the present disclosure, the first core network device may be the unified data management (UDM) in the home network HPLMN. The terminal may receive the capability request message sent by the UDM through the AMF in the visited network VPLMN.

Alternatively, the capability of the terminal is the UPU capability or the SoR capability of the terminal, and the UPU capability or the SoR capability of the terminal may indicate whether the terminal supports slice-based SoR information.

In the embodiment of the present disclosure, the capability request message includes at least one of UPU counter Counter_{UPU} or second indication information; where the second indication information is configured to indicate security protection algorithm used by the terminal, and the security protection algorithm includes integrity protection algorithm and confidentiality protection algorithm.

As a possible implementation, the capability request message includes the UPU counter Counter_{UPU}.

As another possible implementation, the capability request message includes the UPU counter CounterUPU and the second indication information.

In the embodiment of the present disclosure, the UPU counter Counter_{UPU} and the second indication information are determined by the authentication server function (AUSF).

It should be noted that reference can be made to the technical specification (TS) 33.501 of the 3GPP for the definition of the UPU counter Counter_{UPU}.

Step 202: at least one piece of first information or an identifier of a terminal is sent to the first core network device through the visited network according to the capability request message.

In the embodiment of the present disclosure, after receiving the capability request message, the terminal may send at least one piece of the first information or the identifier of the terminal to the first core network device according to the capability request message, where the first information may indicate the capability of the terminal.

The first information includes first indication information and an integrity check code, and the first indication information is configured to indicate the capability of the terminal.

Alternatively, the first indication information is configured to indicate the UPU or the SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

Alternatively, the identifier of the terminal may be a subscription permanent identifier (SUPI) of the terminal or a subscription concealed identifier (SUCI) of the terminal.

The terminal may not send the identifier of the terminal to the first core network device, and the first core network device may obtain the SUPI of the terminal through a session parameter.

In some implementations, the capability request message received by the terminal includes the UPU counter CounterUPU. The terminal may generate the integrity check code UC-MAC1-I_{UE}, by using preset integrity protection algorithm, according to a security key K_{AUSF} corresponding to the terminal, the UPU counter Counter_{UPU} in the capability request message, and the first indication information; and send the first information including the first indication information and the integrity check code UC-MAC1-I_{UE} to the first core network device.

In some implementations, the capability request message received by the terminal includes the UPU counter Counter_{UPU} and the second indication information; where the second indication information only indicates the integrity protection algorithm. The terminal may generate the integrity check code UC-MAC1-I_{UE}, by using the integrity protection algorithm indicated in the second indication information, according to a security key K_{AUSF} corresponding to the terminal, the UPU counter Counter_{UPU} in the capability request message, and the first indication information; and send the first information including the first indication information and the integrity check code UC-MAC1-I_{UE} to the first core network device.

In some implementations, the capability request message received by the terminal includes the UPU counter Counter_{UPU} and the second indication information. The terminal may obtain encrypted first indication information by encrypting the first indication information by using the confidentiality protection algorithm indicated in the second indication information according to a security key K_{AUSF} and the UPU counter Counter_{UPU}. Then, the terminal may generate the integrity check code UC-MAC1-I_{UE}, by using the integrity protection algorithm indicated in the second indication information according to the security key K_{AUSF}, the UPU counter Counter_{UPU}, and the encrypted first indication information; and send the first information including the encrypted first indication information and the integrity check code UC-MAC1-I_{UE} to the first core network device.

In some implementations, the capability request message received by the terminal includes the UPU counter Counter_{UPU} and the second indication information. The terminal may generate the integrity check code UC-MAC1-I_{UE} by using the integrity protection algorithm indicated in the second indication information according to the security key K_{AUSF}, the UPU counter Counter_{UPU}, and the first indication information. Then, the terminal may obtain the first information by encrypting the first indication information and the integrity check code UC-MAC1-I_{UE} by using the confidentiality protection algorithm indicated in the second indication information according to the security key K_{AUSF} and the UPU counter Counter_{UPU}; and send the first information to the first core network device.

In other words, if the capability request message received by the terminal includes the UPU counter, but does not include the second indication information indicating the security protection algorithm, the terminal protects an indication procedure of the capability through the security mechanism for integrity protection. If the capability request message received by the terminal includes the UPU counter and the second indication information indicating the security protection algorithm, the terminal protects an indication procedure of the capability through the security mechanism for integrity and confidentiality protection.

In a case of the security mechanism for integrity and confidentiality protection, alternatively, the terminal may encrypt the first indication information by using the confidentiality protection algorithm at first, and then generate the integrity check code; and alternatively, the terminal may generate the integrity check code at first, and then encrypt the generated integrity check code and the first indication information by using the confidentiality protection algorithm.

In the embodiment of the present disclosure, the first information sent to the first core network device by the terminal is forwarded to the second core network device for verification. The second core network device is the authentication server function (AUSF).

It should be noted that in each embodiment of the present disclosure, the security key K_{AUSF} corresponding to the terminal is a key generated by the AUSF in the home network of the terminal when the terminal during initial registration. The terminal and the AUSF store the security key K_{AUSF}, and the security key K_{AUSF} corresponds to the terminal.

It can be understood that in each embodiment of the present disclosure, information interaction between the terminal and the core network device is completed through transparent transmission of the access network device.

In conclusion, the capability request message sent by the first core network device through the visited network is received, and at least one piece of the first information or the identifier of the terminal is sent to the first core network device through the visited network according to the capability request message. The first information includes the first indication information and the integrity check code, and the first indication information is configured to indicate the capability of the terminal. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 3, FIG. 3 is a schematic flowchart of a method for indicating the capability of the terminal according to an embodiment of the present disclosure. It should be noted that the method for indicating the capability of the terminal according to the embodiment of the present disclosure is performed by the terminal. The method may be performed alone or in conjunction with any one of the other embodiments of the present disclosure. As shown in FIG. 3, the method may include:

Step 301: a capability request message sent by a first core network device of a home network through a visited network is received, where the capability request message includes UPU counter.

In the embodiment of the present disclosure, the terminal may receive the capability request message sent by the first core network device through the visited network, where the capability request message is configured to request the terminal to indicate the capability of the terminal to the first core network device.

In the embodiment of the present disclosure, the capability request message received by the terminal includes the UPU counter Counter_{UPU} only.

In the embodiment of the present disclosure, the first core network device may be the unified data management (UDM) in the home network HPLMN. The terminal may receive the capability request message sent by the UDM through the AMF in the visited network VPLMN.

In some implementations, the UDM may send a Nudm subscriber data management notification (Nudm_SDM_Notify) message including the capability request message to the AMF. Then, the AMF may send a downlink non-access stratum transport (DL NAS TRANSPORT) message including the capability request message to the terminal.

In some implementations, the capability request message may be user equipment parameter update (UPU) transparent container, and the UPU transparent container may include the UPU counter Counter_{UPU}.

Alternatively, the capability of the terminal is a UPU capability or a SoR capability of the terminal, and the UPU capability or the SoR capability of the terminal may indicate whether the terminal supports slice-based SoR information.

In the embodiment of the present disclosure, the UPU counter Counter_{UPU} is determined by the authentication server function (AUSF).

It should be noted that reference can be made to the technical specification (TS) 33.501 of the 3GPP for the definitions of the UPU transparent container and the UPU counter Counter_{UPU}.

Step 302, an integrity check code is generated by using preset integrity protection algorithm according to a security key K_{AUSF} corresponding to a terminal, the UPU counter, and first indication information.

In the embodiment of the present disclosure, the capability request message received by the terminal includes the UPU counter CounterUPU only. The terminal employs a security mechanism for integrity protection. The terminal may generate the integrity check code UC-MAC1-I_{UE} by using the preset integrity protection algorithm according to the security key K_{AUSF} corresponding to the terminal, the UPU counter Counter_{UPU}, and the first indication information.

The first indication information is configured to indicate the capability of the terminal.

Alternatively, the first indication information is configured to indicate the UPU capability or the SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

In some implementations, the first indication information may be UPU acknowledgement transparent container (UPU ACK transparent container) in a non-access stratum uplink transport (NAS UL TRANSPORT) message. The first indication information also may be the capability information of the terminal and included in the UPU ACK transparent container.

In some implementations, the integrity check code UC-MAC1-I_{UE} may be generated by using a key derivation function (KDF).

Alternatively, an input parameter KEY of the key derivation function (KDF) for generating the integrity check code UC-MAC1-I_{UE} is the security key K_{AUSF}. An input parameter S of the key derivation function (KDF) may include:
a key derivation function code FC;
a parameter P0 indicates the first indication information;
a parameter L0 indicates a length of data included in the parameter P0, i.e. a length of data of the first indication information;
a parameter P1 indicates the UPU counter Counter_{UPU}; and
a parameter L1 indicates a length of the UPU counter Counter_{UPU}.

In the embodiment of the present disclosure, the preset integrity protection algorithm may be specified by a protocol or indicated by a network side.

Step 303: at least one piece of first information or an identifier of the terminal is sent to the first core network device through the visited network, where the first information includes the first indication information and the integrity check code.

In the embodiment of the present disclosure, after generating the integrity check code UC-MAC1-I_{UE}, the terminal may send the first information to the first core network device through the visited network, where the first information includes the first indication information and the integrity check code UC-MAC1-I_{UE} generated in step 302.

In some implementations, the terminal may send the NAS UL TRANSPORT message including the first information and the identifier of the terminal to the AMF. Then, the AMF may send a Nudm subscriber data management information (Nudm_SDM_Info) message including the first information and the identifier of the terminal to the UDM.

Alternatively, the identifier of the terminal may be a subscription permanent identifier (SUPI) of the terminal or a subscription concealed identifier (SUCI) of the terminal.

In the embodiment of the present disclosure, the first information sent to the first core network device UDM by the terminal is forwarded to a second core network device for verification. The second core network device is the authentication server function (AUSF).

In conclusion, the capability request message sent by the first core network device of the home network through the visited network is received, where the capability request message includes the UPU counter. The integrity check code is generated through the security key K_{AUSF} corresponding to the terminal, the UPU counter, and the first indication information. The first information is sent to the first core network device through the visited network, where the first information includes the first indication information and the integrity check code. Thus, the terminal can resist sniffing, removing, or tampering by the visited network on the information sent by the terminal, and security indicate its own capability information to the home network. Accordingly, security of information interaction between the terminal and the home network is protected, and security of the system is improved.

With reference to FIG. 4, FIG. 4 is a schematic flowchart of a method for indicating the capability of the terminal according to an embodiment of the present disclosure. It should be noted that the method for indicating the capability of the terminal according to the embodiment of the present disclosure is performed by the terminal. The method may be performed alone or in conjunction with any one of the other embodiments of the present disclosure. As shown in FIG. 4, the method may include:

Step 401: a capability request message sent by a first core network device of a home network through a visited network is received, where the capability request message includes UPU counter and second indication information.

In the embodiment of the present disclosure, the terminal may receive the capability request message sent by the first core network device through the visited network, where the capability request message is configured to request the terminal to indicate the capability of the terminal to the first core network device.

In the embodiment of the present disclosure, the capability request message received by the terminal includes the UPU counter CounterUPU and the second indication information. The second indication information is configured to indicate security protection algorithm used by the terminal, and the security protection algorithm includes integrity protection algorithm and confidentiality protection algorithm.

In the embodiment of the present disclosure, the first core network device may be the unified data management (UDM) in the home network HPLMN. The terminal may receive the capability request message sent by the UDM through the AMF in the visited network VPLMN.

In some implementations, the UDM may send the Nudm_SDM_Notify message including the capability request message to the AMF. Then, the AMF may send the DL NAS TRANSPORT message including the capability request message to the terminal.

In some implementations, the capability request message may be UPU transparent container, and the UPU transparent container may include the UPU counter Counter_{UPU} and the second indication information.

Alternatively, the capability of the terminal is a UPU capability or a SoR capability of the terminal, and the UPU capability or the SoR capability of the terminal may indicate whether the terminal supports slice-based SoR information.

In the embodiment of the present disclosure, the UPU counter Counter_{UPU} and the second indication information are determined by the authentication server function (AUSF). The AUSF may select the security protection algorithm according to its own security capability and a security capability of the terminal.

It should be noted that reference can be made to the technical specification (TS) 33.501 of the 3GPP for the definitions of the UPU transparent container and the UPU counter Counter_{UPU}.

Step 402: encrypted first indication information is obtained by encrypting the first indication information by using confidentiality protection algorithm indicated in the second indication information according to a security key K_{AUSF} corresponding to the terminal and the UPU counter.

In the embodiment of the present disclosure, the capability request message received by the terminal includes the UPU counter Counter_{UPU} and the second indication information. The terminal employs a security mechanism for integrity and confidentiality protection according to indication of the second indication information. The terminal may obtain the encrypted first indication information by encrypting the first indication information by using the confidentiality protection algorithm indicated in the second indication information according to the security key K_{AUSF} corresponding to the terminal and the UPU counter in a manner that the confidentiality protection is performed at first, and then the integrity check code is generated.

The first indication information is configured to indicate the capability of the terminal.

Alternatively, the first indication information is configured to indicate the UPU capability or the SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

In some implementations, the first indication information may be the UPU acknowledgement transparent container (UPU ACK transparent container) in the NAS UL TRANSPORT message. The first indication information also may be the capability information of the terminal and included in the UPU ACK transparent container.

In some implementations, an input parameter of the confidentiality protection algorithm may be as follows:
a parameter KEY indicates the security key K_{AUSF};
a parameter COUNT indicates the UPU counter Counter_{UPU};
0x00 indicates a parameter BEARER;
0x00 indicates a parameter DIRECTION; and
LEN (first indication information) indicates a parameter LENGTH, where LEN (x) indicates a length of x (in number of bits).

The confidentiality protection algorithm may be selected and determined by the AUSF according to its own security capability and a security capability of the terminal, and indicated to the terminal through the second indication information.

It should be noted that reference can be made to provisions in the Annex D.2 of the technical specification (TS) 33.501 of the 3GPP for the use and operation mode of the confidentiality protection algorithm.

Step 403: an integrity check code is generated by using integrity protection algorithm indicated in the second indication information according to the security key K_{AUSF}, the UPU counter, and the encrypted first indication information.

In the embodiment of the present disclosure, after encrypting the first indication information by using the confidentiality protection algorithm indicated in the second indication information, the terminal may generate the integrity check code UC-MAC1-I_{UE} by using the integrity protection algorithm indicated in the second indication information according to the security key K_{AUSF}, the UPU counter Counter_{UPU}, and the encrypted first indication information.

In some implementations, the integrity check code UC-MAC1-I_{UE} may be generated by using a key derivation function (KDF).

Alternatively, an input parameter KEY of the key derivation function (KDF) for generating the integrity check code UC-MAC1-I_{UE} is the security key K_{AUSF}. An input parameter S of the key derivation function (KDF) may include:
a key derivation function code FC;
a parameter P0 indicates the encrypted first indication information;
a parameter L0 indicates a length of data included in the parameter P0, i.e. a length of data of the encrypted first indication information;
a parameter P1 indicates the UPU counter Counter_{UPU}; and
a parameter L1 indicates a length of the UPU counter Counter_{UPU}.

Step 404: at least one piece of first information or an identifier of the terminal is sent to the first core network device through the visited network, where the first information includes the encrypted first indication information and the integrity check code.

In the embodiment of the present disclosure, after generating the integrity check code UC-MAC1-I_{UE}, the terminal may send the first information to the first core network device through the visited network. The first information includes the encrypted first indication information generated in step 402 and the integrity check code UC-MAC1-I_{UE} generated in step 403.

In some implementations, the terminal may send the NAS UL TRANSPORT message including the first information and the identifier of the terminal to the AMF. Then, the AMF may send the Nudm_SDM_Info message including the first information and the identifier of the terminal to the UDM.

Alternatively, the identifier of the terminal may be the SUPI of the terminal or the SUCI of the terminal.

In the embodiment of the present disclosure, the first information sent to the first core network device UDM by the terminal is forwarded to a second core network device for verification. The second core network device is the authentication server function (AUSF).

In conclusion, the capability request message sent by the first core network device of the home network through the visited network is received, where the capability request message includes the UPU counter and the second indication information. The encrypted first indication information is obtained by encrypting the first indication information by using the confidentiality protection algorithm indicated in the second indication information according to the security key K_{AUSF} corresponding to the terminal and the UPU counter. The integrity check code is generated according to the security key K_{AUSF}, the UPU counter, and the encrypted first indication information. The first information is sent to the first core network device through the visited network, where the first information includes the encrypted first indication information and the integrity check code. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 5, FIG. 5 is a schematic flowchart of a method for indicating the capability of the terminal according to an embodiment of the present disclosure. It should be noted that the method for indicating the capability of the terminal according to the embodiment of the present disclosure is performed by the terminal. The method may be performed alone or in conjunction with any one of the other embodiments of the present disclosure. As shown in FIG. 5, the method may include:

Step 501: a capability request message sent by a first core network device of a home network through a visited network is received, where the capability request message includes UPU counter and second indication information.

In the embodiment of the present disclosure, the terminal may receive the capability request message sent by the first core network device through the visited network, where the capability request message is configured to request the terminal to indicate the capability of the terminal to the first core network device.

In the embodiment of the present disclosure, the capability request message received by the terminal includes the UPU counter Counter_{UPU} and the second indication information. The second indication information is configured to indicate security protection algorithm used by the terminal, and the security protection algorithm includes integrity protection algorithm and confidentiality protection algorithm.

In the embodiment of the present disclosure, the first core network device may be the unified data management (UDM) in the home network HPLMN. The terminal may receive the capability request message sent by the UDM through the AMF in the visited network VPLMN.

In some implementations, the UDM may send the Nudm_SDM_Notify message including the capability request message to the AMF. Then, the AMF may send the DL NAS TRANSPORT message including the capability request message to the terminal.

In some implementations, the capability request message may be UPU transparent container, and the UPU transparent container may include the UPU counter Counter_{UPU} and the second indication information.

Alternatively, the capability of the terminal is a UPU capability or a SoR capability of the terminal, and the UPU capability or the SoR capability of the terminal may indicate whether the terminal supports slice-based SoR information.

In the embodiment of the present disclosure, the UPU counter Counter_{UPU} and the second indication information are determined by the authentication server function (AUSF). The AUSF may select the security protection algorithm according to its own security capability and a security capability of the terminal.

It should be noted that reference can be made to the technical specification (TS) 33.501 of the 3GPP for the definitions of the UPU transparent container and the UPU counter Counter_{UPU}.

Step 502: an integrity check code is generated by using integrity protection algorithm indicated in the second indication information according to a security key K_{AUSF} corresponding to the terminal, the UPU counter, and first indication information.

In the embodiment of the present disclosure, the capability request message received by the terminal includes the UPU counter Counter_{UPU} and the second indication information. The terminal employs a security mechanism for integrity and confidentiality protection according to indication of the second indication information. The terminal may generate the integrity check code UC-MAC1-I_{UE} according to the security key K_{AUSF} corresponding to the terminal, the UPU counter, and the first indication information in a manner that the integrity check code is generated at first, and then the confidentiality protection is performed.

The first indication information is configured to indicate the capability of the terminal.

Alternatively, the first indication information is configured to indicate the UPU capability or the SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

In some implementations, the first indication information may be the UPU acknowledgement transparent container (UPU ACK transparent container) in the NAS UL TRANSPORT message. The first indication information also may be the capability information of the terminal and included in the UPU ACK transparent container.

In some implementations, the integrity check code UC-MAC1-I_{UE} may be generated by using a key derivation function (KDF).

Alternatively, an input parameter KEY of the key derivation function (KDF) for generating the integrity check code UC-MAC1-I_{UE} is the security key K_{AUSF}. An input parameter S of the key derivation function (KDF) may include:
a key derivation function code FC;
a parameter P0 indicates the first indication information;
a parameter L0 indicates a length of data included in the parameter P0, i.e. a length of data of the first indication information;
a parameter P1 indicates the UPU counter Counter_{UPU}; and
a parameter L1 indicates a length of the UPU counter Counter_{UPU}.

Step 503: first information is obtained by encrypting the first indication information and the integrity check code by using the confidentiality protection algorithm indicated in the second indication information according to the security key K_{AUSF} and the UPU counter.

In the embodiment of the present disclosure, after generating the integrity check code UC-MAC1-I_{UE}, the terminal may obtain the first information by encrypting the first indication information and the integrity check code UC-MAC1-I_{UE} by using the confidentiality protection algorithm indicated in the second indication information.

In some implementations, an input parameter of the confidentiality protection algorithm may be as follows:
a parameter KEY indicates the security key K_{AUSF};
a parameter COUNT indicates the UPU counter Counter_{UPU};
0x00 indicates a parameter BEARER;
0x00 indicates a parameter DIRECTION; and
LEN (first indication information and integrity check code UC-MAC1-I_{UE}) indicates a parameter LENGTH, where LEN (x) indicates a length of x (in number of bits).

The confidentiality protection algorithm may be selected and determined by the AUSF according to its own security capability and a security capability of the terminal, and indicated to the terminal through the second indication information.

It should be noted that reference can be made to provisions in the Annex D.2 of the technical specification (TS) 33.501 of the 3GPP for the use and operation mode of the confidentiality protection algorithm.

Step 504: at least one piece of the first information or an identifier of the terminal is sent to the first core network device through the visited network.

In the embodiment of the present disclosure, the terminal may send the first information and the identifier of the terminal to the first core network device through the visited network. The first information is obtained by encrypting the first indication information and the integrity check code UC-MAC 1-I_{UE} generated in step 502.

In some implementations, the terminal may send the NAS UL TRANSPORT message including the first information and the identifier of the terminal to the AMF. Then, the AMF may send the Nudm_SDM_Info message including the first information and the identifier of the terminal to the UDM.

Alternatively, the identifier of the terminal may be the SUPI of the terminal or the SUCI of the terminal.

In the embodiment of the present disclosure, the first information sent to the first core network device UDM by the terminal is forwarded to a second core network device for verification. The second core network device is the authentication server function (AUSF).

In conclusion, the capability request message sent by the first core network device of the home network through the visited network is received, where the capability request message includes the UPU counter and the second indication information. The integrity check code is generated according to the security key K_{AUSF} corresponding to the terminal, the UPU counter, and the encrypted first indication information. The first information is obtained by encrypting the first indication information and the integrity check code by using the confidentiality protection algorithm indicated in the second indication information according to the security key K_{AUSF} and the UPU counter. The first information is sent to the first core network device through the visited network. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

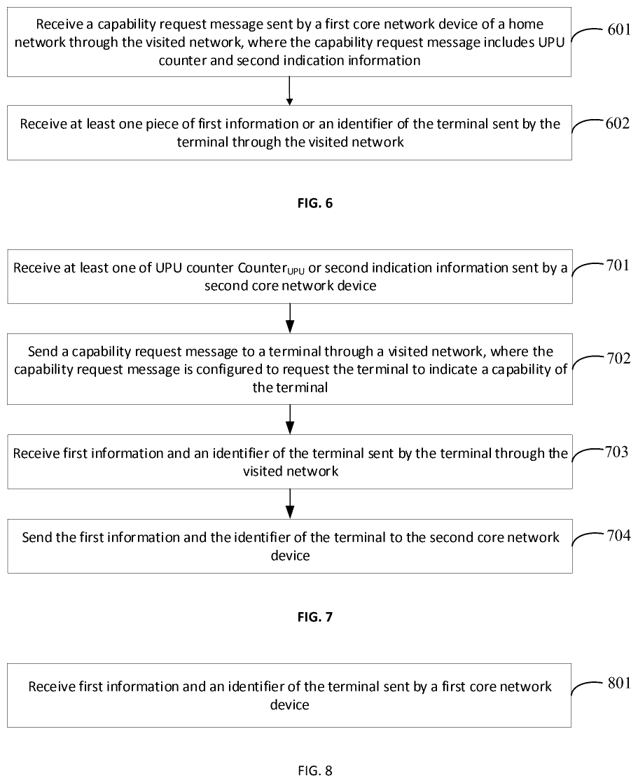

With reference to FIG. 6, FIG. 6 is a schematic flowchart of a method for indicating a capability of a terminal according to an embodiment of the present disclosure. It should be noted that the method for indicating the capability of the terminal according to the embodiment of the present disclosure is performed by a first core network device. The method may be performed alone or in conjunction with any one of the other embodiments of the present disclosure. As shown in FIG. 6, the method may include:

Step 601: a capability request message is sent to the terminal through the visited network, where the capability request message is configured to request the terminal to indicate the capability of the terminal.

In the embodiment of the present disclosure, the first core network device may send the capability request message to the terminal through the visited network VPLMN. After receiving the capability request message, the terminal may return the capability of the terminal to the first core network device.

In the embodiment of the present disclosure, the first core network device may be the unified data management (UDM) in the home network HPLMN. The UDM may send the capability request message to the terminal through the AMF in the visited network VPLMN.

Alternatively, the capability of the terminal is a UPU capability or a SoR capability of the terminal, and the UPU capability or the SoR capability of the terminal may indicate whether the terminal supports slice-based SoR information.

In some implementations, the first core network device may receive at least one of UPU counter Counter_{UPU} or second indication information sent by a second core network device. The capability request message sent to the terminal by the first core network device includes at least one of the UPU counter Counter_{UPU} or the second indication information. The second indication information is configured to indicate security protection algorithm used by the terminal, and the security protection algorithm includes integrity protection algorithm and confidentiality protection algorithm.

As a possible implementation, the first core network device may receive the UPU counter Counter_{UPU} sent by the second core network device. The capability request message includes the UPU counter Counter_{UPU}.

As another possible implementation, the first core network device may receive the UPU counter Counter_{UPU} and the second indication information sent by the second core network device. The capability request message includes the UPU counter Counter_{UPU} and the second indication information.

In the embodiment of the present disclosure, the second core network device may be the authentication server function (AUSF) in the home network HPLMN. The UPU counter Counter_{UPU} and the second indication information are determined by the AUSF.

It should be noted that reference can be made to the technical specification (TS) 33.501 of the 3GPP for the definition of the UPU counter Counter_{UPU}.

In each embodiment of the present disclosure, the first core network device UDM determines whether the terminal supports the slice-based SoR information by deciding to obtain the capability of the terminal.

Alternatively, the UDM may determine to trigger obtaining of the UPU capability or the SoR capability of the terminal based on, for example, a local configuration, a location of the terminal in a specific public land mobile network (PLMN), or indication information sent to the UDM by a steering of roaming application function (SoR AF).

Step 602: at least one piece of first information or an identifier of the terminal sent by the terminal through the visited network is received.

In the embodiment of the present disclosure, after sending the capability request message to the terminal, the first core network device may receive the first information returned by the terminal through the visited network. The first information includes first indication information and the integrity check code, and the first indication information is configured to indicate the capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

Alternatively, the received identifier of the terminal may be the SUPI or the SUCI of the terminal.

Alternatively, the first core network device may receive the SUPI or the SUCI sent by the terminal or obtain the SUPI of the terminal from a session parameter and then send the SUPI to the second core network device.

In some implementations, in a case where the capability request message includes the UPU counter Counter_{UPU}, the first information received by the first core network device includes the first indication information and the integrity check code. The integrity check code is generated by using preset integrity protection algorithm according to a security key K_{AUSF} corresponding to the terminal, the UPU counter Counter_{UPU}, and the first indication information.

In some implementations, in a case where the capability request message includes the UPU counter Counter_{UPU} and the second indication information, the capability request message indicates the integrity protection algorithm only. The terminal may generate an integrity check code UC-MAC1-I_{UE} by using the integrity protection algorithm indicated in the second indication information according to a security key K_{AUSF} corresponding to the terminal, the UPU counter Counter_{UPU} in the capability request message, and the first indication information; and send the first information including the first indication information and the integrity check code UC-MAC1-I_{UE} to the first core network device.

In some implementations, in a case where the capability request message includes the UPU counter Counter_{UPU} and the second indication information, the first information received by the first core network device includes encrypted first indication information and the integrity check code. The encrypted first indication information is obtained by encrypting the first indication information by using the confidentiality protection algorithm indicated in the second indication information according to a security key K_{AUSF} corresponding to the terminal and the UPU counter Counter_{UPU}. The integrity check code is generated by using the integrity protection algorithm indicated in the second indication information according to the security key K_{AUSF}, the UPU counter Counter_{UPU}, and the encrypted first indication information.

In some implementations, in a case where the capability request message includes the UPU counter Counter_{UPU} and the second indication information, the first information received by the first core network device is obtained by encrypting the first indication information and the integrity check code by using the confidentiality protection algorithm indicated in the second indication information according to a security key K_{AUSF} and the UPU counter Counter_{UPU}. The integrity check code is generated by using the integrity protection algorithm indicated in the second indication information according to the security key K_{AUSF}, the UPU counter Counter_{UPU}, and the first indication information.

In the embodiment of the present disclosure, the first core network device may send the first information and the identifier of the terminal to the second core network device. Thus, the second core network device verifies whether the first information is tampered according to the integrity check code in the first information. Alternatively, the identifier of the terminal is the SUPI of the terminal.

In the embodiment of the present disclosure, the first core network device may also receive a verified first indication information sent by the second core network device, determine the capability of the terminal according to the verified first indication information, and determine whether the terminal supports the slice-based SoR information.

It can be understood that in the embodiment of the present disclosure, after obtaining the capability of the terminal, the first core network device may request the slice-based SoR information, etc. from the SoR AF according to the capability of the terminal.

In conclusion, the capability request message is sent to the terminal through the visited network, where the capability request message is configured to request the terminal to indicate the capability of the terminal. The first information sent by the terminal through the visited network is received. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 7, FIG. 7 is a schematic flowchart of a method for indicating the capability of the terminal according to an embodiment of the present disclosure. It should be noted that the method for indicating the capability of the terminal according to the embodiment of the present disclosure is performed by a first core network device. The method may be performed alone or in conjunction with any one of the other embodiments of the present disclosure. As shown in FIG. 7, the method may include:

Step 701, at least one of UPU counter Counter_{UPU} or second indication information sent by a second core network device is received.

In the embodiment of the present disclosure, the first core network device may receive at least one of the UPU counter Counter_{UPU} or the second indication information sent by the second core network device. The second indication information is configured to indicate security protection algorithm used by the terminal, and the security protection algorithm includes integrity protection algorithm and confidentiality protection algorithm.

In the embodiment of the present disclosure, the first core network device may be the unified data management (UDM) in the home network HPLMN, and the second core network device may be the authentication server function (AUSF) in the HPLMN.

As a possible implementation, the first core network device may receive the UPU counter Counter_{UPU} sent by the second core network device.

As another possible implementation, the first core network device may receive the UPU counter Counter_{UPU} and the second indication information that are sent by the second core network device.

In the embodiment of the present disclosure, the UPU counter Counter_{UPU} and the second indication information are determined by the AUSF.

It should be noted that reference can be made to the technical specification (TS) 33.501 of the 3GPP for the definition of the UPU counter Counter_{UPU}.

Step 702: a capability request message is sent to a terminal through a visited network, where the capability request message is configured to request the terminal to indicate the capability of the terminal.

In the embodiment of the present disclosure, the first core network device may send the capability request message to the terminal through the visited network VPLMN. After receiving the capability request message, the terminal may return the capability of the terminal to the first core network device.

In the embodiment of the present disclosure, the UDM sends the capability request message to the terminal through the AMF in the visited network VPLMN.

In some implementations, the UDM may send the Nudm_SDM_Notify message including the capability request message to the AMF. Then, the AMF may send the DL NAS TRANSPORT message including the capability request message to the terminal.

Alternatively, the capability of the terminal is a UPU capability or a SoR capability of the terminal, and the UPU capability or the SoR capability of the terminal may indicate whether the terminal supports slice-based SoR information.

In some implementations, the first core network device may receive the UPU counter Counter_{UPU} sent by the second core network device. The capability request message sent to the terminal includes the UPU counter Counter_{UPU}.

In some implementations, the first core network device may receive the UPU counter Counter_{UPU} and the second indication information that are sent by the second core network device. The capability request message sent to the terminal includes the UPU counter Counter_{UPU} and the second indication information.

In some implementations, the capability request message may be UPU transparent container, and the UPU transparent container may include at least one of the UPU counter Counter_{UPU} or the second indication information.

Step 703: at least one piece of first information or an identifier of the terminal sent by the terminal through the visited network is received.

In the embodiment of the present disclosure, after sending the capability request message to the terminal, the first core network device may receive the first information returned by the terminal through the visited network. The first information includes first indication information and an integrity check code, and the first indication information is configured to indicate the capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

In some implementations, in a case where the capability request message includes the UPU counter Counter_{UPU}, the first information received by the first core network device includes the first indication information and the integrity check code. The integrity check code is generated by using preset integrity protection algorithm according to a security key K_{AUSF} corresponding to the terminal, the UPU counter Counter_{UPU}, and the first indication information.

In some implementations, in a case where the capability request message includes the UPU counter Counter_{UPU} and the second indication information, the first information received by the first core network device includes encrypted first indication information and the integrity check code. The encrypted first indication information is obtained by encrypting the first indication information by using the confidentiality protection algorithm indicated in the second indication information according to a security key K_{AUSF} corresponding to the terminal and the UPU counter Counter_{UPU}. The integrity check code is generated by using the integrity protection algorithm indicated in the second indication information according to the security key K_{AUSF}, the UPU counter Counter_{UPU}, and the encrypted first indication information.

In some implementations, in a case where the capability request message includes the UPU counter Counter_{UPU} and the second indication information, the first information received by the first core network device is obtained by encrypting the first indication information and the integrity check code by using the confidentiality protection algorithm indicated in the second indication information according to a security key K_{AUSF} and the UPU counter Counter_{UPU}. The integrity check code is generated by using the integrity protection algorithm indicated in the second indication information according to the security key K_{AUSF}, the UPU counter Counter_{UPU}, and the first indication information.

In some implementations, the terminal may send the NAS UL TRANSPORT message including the first information and the identifier of the terminal to the AMF. Then, the AMF may send the Nudm_SDM_Info message including the first information and the identifier of the terminal to the UDM.

Alternatively, the identifier of the terminal may be the SUPI of the terminal or the SUCI of the terminal.

Step 704: the first information and the identifier of the terminal are sent to the second core network device.

In the embodiment of the present disclosure, the first core network device may send the first information and the identifier of the terminal to the second core network device.

The integrity check code in the first information is configured for the second core network device to verify whether the first information is tampered.

Alternatively, the identifier of the terminal is the SUPI.

It can be understood that if the identifier of the terminal obtained by the first core network device is the SUPI, the first core network device directly sends the SUPI of the terminal to the second core network device. If the identifier of the terminal obtained by the first core network device is the SUCI, the first core network device obtains the SUPI of the terminal by decrypting the SUCI and sends the SUPI to the second core network device.

In the embodiment of the present disclosure, the first core network device may also receive the verified first indication information sent by the second core network device, determine the capability of the terminal according to the verified first indication information, and determine whether the terminal supports the slice-based SoR information.

It can be understood that in the embodiment of the present disclosure, after obtaining the capability of the terminal, the first core network device may request the slice-based SoR information, etc. from the SoR AF according to the capability of the terminal.

In conclusion, at least one of the UPU counter Counter_{UPU} or the second indication information sent by the second core network device is received. The capability request message is sent to the terminal through the visited network, where the capability request message is configured to request the terminal to indicate the capability of the terminal. The first information sent by the terminal through the visited network is received. The first information is sent to the second core network device. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

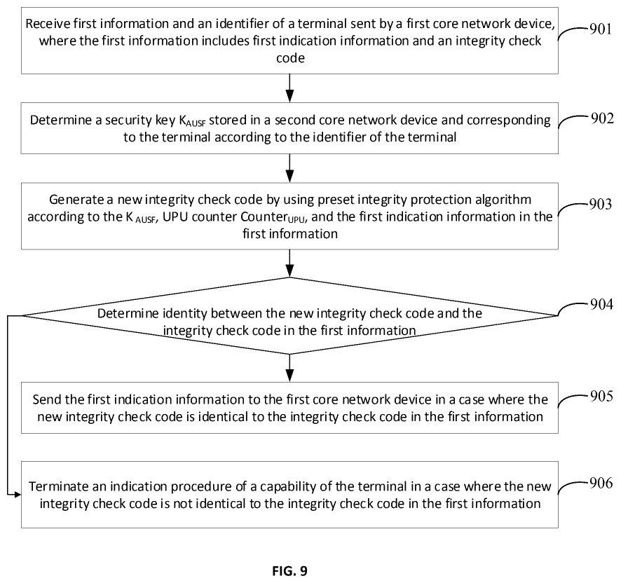

With reference to FIG. 8, FIG. 8 is a schematic flowchart of a method for indicating a capability of a terminal according to an embodiment of the present disclosure. It should be noted that the method for indicating the capability of the terminal according to the embodiment of the present disclosure is performed by a second core network device. The method may be performed alone or in conjunction with any one of the other embodiments of the present disclosure. As shown in FIG. 8, the method may include:

Step 801: first information and an identifier of the terminal sent by a first core network device are received.

The first information includes first indication information and an integrity check code, and the first indication information is configured to indicate the capability of the terminal.

In the embodiment of the present disclosure, the second core network device may receive the first information and the identifier of the terminal that are sent by the first core network device, and verify whether the first information is tampered according to the integrity check code included in the first information.

In the embodiment of the present disclosure, the first core network device may be the unified data management (UDM) in the home network HPLMN, and the second core network device may be the authentication server function (AUSF) in the HPLMN.

Alternatively, the first indication information is configured to indicate a UPU capability or a SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

In some implementations, the second core network device may send at least one of UPU counter or second indication information to the first core network device. The second indication information is configured to indicate security protection algorithm used by the terminal, and the security protection algorithm includes integrity protection algorithm and confidentiality protection algorithm.

As a possible implementation, the second core network device may send the UPU counter Counter_{UPU} to the first core network device.

As another possible implementation, the second core network device may send the UPU counter Counter_{UPU} and the second indication information to the first core network device.

Alternatively, the security protection algorithm indicated in the second indication information may be selected and determined by the second core network device according to its own security capability and a security capability of the terminal, and indicated to the terminal through the second indication information.

In the embodiment of the present disclosure, the second core network device receives the identifier of the terminal sent by the first core network device, and determines a security key K_{AUSF} stored in the second core network device and corresponding to the terminal according to the identifier of the terminal.

Alternatively, the identifier of the terminal is the SUPI.

In some implementations, in a case where the received first information includes the first indication information and the integrity check code, the second core network device may determine the security key K_{AUSF} stored in the second core network device and corresponding to the terminal according to the identifier of the terminal; then generate a new integrity check code by using preset integrity protection algorithm according to the security key K_{AUSF}, the UPU counter Counter_{UPU}, and the first indication information in the first information; and determine identity between the new integrity check code and the integrity check code in the first information.

The first indication information is sent to the first core network device in a case where the new integrity check code is identical to the integrity check code in the first information.

An indication procedure of the capability of the terminal is terminated in a case where the new integrity check code is not identical to the integrity check code in the first information.

In some implementations, in a case where the received first information includes encrypted first indication information and the integrity check code, the second core network device may determine the security key K_{AUSF} stored in the second core network device and corresponding to the terminal according to the identifier of the terminal; then generate a new integrity check code by using the integrity protection algorithm indicated in the second indication information according to the security key K_{AUSF}, the UPU counter Counter_{UPU}, and the encrypted first indication information in the first information; and determine identity between the new integrity check code and the integrity check code in the first information.

The first indication information is sent to the first core network device in a case where the new integrity check code is identical to the integrity check code in the first information. The first indication information is obtained by decrypting the encrypted first indication information in the first information by using the confidentiality protection algorithm indicated in the second indication information according to the security key K_{AUSF} and the UPU counter Counter_{UPU}.

An indication procedure of the capability of the terminal is terminated in a case where the new integrity check code is not identical to the integrity check code in the first information.

In some implementations, in a case where the received first information is obtained by encrypting the first indication information and the integrity check code, the second core network device may determine the security key K_{AUSF} stored in the second core network device and corresponding to the terminal according to the identifier of the terminal; then obtain the first indication information and the integrity check code in the first information by decrypting the received first information by using the confidentiality protection algorithm indicated in the second indication information; generate a new integrity check code by using the integrity protection algorithm indicated in the second indication information according to the security key K_{AUSF}, the UPU counter Counter_{UPU}, and the decrypted first indication information; and determine identity between the new integrity check code and the integrity check code in the first information.

The decrypted first indication information is sent to the first core network device in a case where the new integrity check code is identical to the integrity check code in the first information.

An indication procedure of the capability of the terminal is terminated in a case where the new integrity check code is not identical to the integrity check code in the first information.

In conclusion, the first information and the identifier of the terminal sent by the first core network device are received. Whether the first information is tampered may be verified through the integrity check code in the first information. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 9, FIG. 9 is a schematic flowchart of a method for indicating the capability of the terminal according to an embodiment of the present disclosure. It should be noted that the method for indicating the capability of the terminal according to the embodiment of the present disclosure is performed by a second core network device. The method may be performed alone or in conjunction with any one of the other embodiments of the present disclosure. As shown in FIG. 9, the method may include:

Step 901: first information and an identifier of the terminal sent by a first core network device are received, where the first information includes first indication information and an integrity check code.

In the embodiment of the present disclosure, the second core network device may receive the first information and the identifier of the terminal that are sent by the first core network device. The first information includes the first indication information and the integrity check code, and the first indication information is configured to indicate the capability of the terminal.

In the embodiment of the present disclosure, the first core network device may be the unified data management (UDM) in the home network HPLMN, and the second core network device may be the authentication server function (AUSF) in the HPLMN.

Alternatively, the first indication information is configured to indicate a UPU capability or a SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

Alternatively, the first indication information may be the UPU ACK transparent container. The first indication information or may be capability information of the terminal and included in the UPU ACK transparent container.

Alternatively, the identifier of the terminal is the SUPI.

In the embodiment of the present disclosure, after receiving the first information, the second core network device may determine whether the first information is encrypted, and determine that the terminal employs a security mechanism for integrity protection in a case where either the first information or the first indication information in the first information is encrypted.

Step 902, a security key K_{AUSF} stored in the second core network device and corresponding to the terminal is determined according to the identifier of the terminal.

In the embodiment of the present disclosure, the second core network device AUSF may determine the security key K_{AUSF} stored in the second core network device and corresponding to the terminal according to the identifier of the terminal.

Alternatively, the identifier of the terminal is a SUPI.

Step 903, a new integrity check code is generated by using preset integrity protection algorithm according to the K_{AUSF}, UPU counter Counter_{UPU}, and the first indication information in the first information.

In the embodiment of the present disclosure, the UPU counter is determined by the second core network device, and sent to the terminal for security protection.

In some implementations, the new integrity check code may be generated according to a key derivation function (KDF).

Alternatively, an input parameter KEY of the key derivation function (KDF) for generating the new integrity check code is the security key K_{AUSF}. An input parameter S of the key derivation function (KDF) may include:
a key derivation function code FC;
a parameter P0 indicates the first indication information;
a parameter L0 indicates a length of data included in the parameter P0, i.e. a length of data of the first indication information;
a parameter P1 indicates the UPU counter Counter_{UPU}; and
a parameter L1 indicates a length of the UPU counter Counter_{UPU}.

It should be noted that reference can be made to the technical specification (TS) 33.501 of the 3GPP for the definition of the UPU counter Counter_{UPU}.

It can be understood that in each embodiment of the present disclosure, the preset integrity protection algorithm may be specified by a protocol or indicated by a network side.

Step 904: identity between the new integrity check code and the integrity check code in the first information is determined.

In the embodiment of the present disclosure, after generating the new integrity check code, the second core network device may determine whether the new integrity check code generated by the second core network is identical to the integrity check code in the received first information. If yes, step 905 is performed, otherwise step 906 is performed.

Step 905, the first indication information is sent to the first core network device in a case where the new integrity check code is identical to the integrity check code in the first information.

In the embodiment of the present disclosure, in a case where the new integrity check code generated by the second core network device is identical to the integrity check code in the received first information, it indicates that the first information is not tampered and is secure. The second core network device may send the first indication information in the first information to the first core network device. The first core network device may obtain the capability of the terminal according to the first indication information.

Step 906, an indication procedure of the capability of the terminal is terminated in a case where the new integrity check code is not identical to the integrity check code in the first information.

In the embodiment of the present disclosure, in a case where the new integrity check code generated by the second core network device is not identical to the received integrity check code in the received first information, it indicates that the first information may be tampered and is insecure. The second core network device may terminate the indication procedure of the capability of the terminal.

In conclusion, the first information and the identifier of the terminal sent by the first core network device are received, where the first information includes the first indication information and the integrity check code. The security key K_{AUSF} stored in the second core network device and corresponding to the terminal is determined according to the identifier of the terminal. The new integrity check code is generated according to the K_{AUSF}, the UPU counter Counter_{UPU}, and the first indication information in the first information. The identity between the new integrity check code and the integrity check code in the first information is determined. The first indication information is sent to the first core network device in a case where the new integrity check code is identical to the integrity check code in the first information. The indication procedure of the capability of the terminal is terminated in a case where the new integrity check code is not identical to the integrity check code in the first information. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

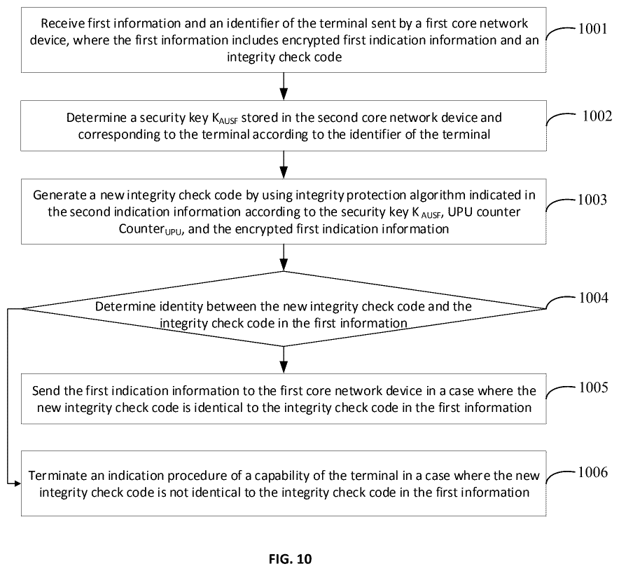

With reference to FIG. 10, FIG. 10 is a schematic flowchart of a method for indicating the capability of the terminal according to an embodiment of the present disclosure. It should be noted that the method for indicating the capability of the terminal according to the embodiment of the present disclosure is performed by a second core network device. The method may be performed alone or in conjunction with any one of the other embodiments of the present disclosure. As shown in FIG. 10, the method may include:

Step 1001: first information and an identifier of the terminal sent by a first core network device are received, where the first information includes encrypted first indication information and an integrity check code.

In the embodiment of the present disclosure, the second core network device may receive the first information and the identifier of the terminal sent by the first core network device. The first information includes the encrypted first indication information and the integrity check code, and the first indication information is configured to indicate the capability of the terminal.

It can be understood that the terminal obtains the encrypted first indication information by encrypting the first indication information by using confidentiality protection algorithm indicated in the second indication information according to a security key K_{AUSF} and UPU counter.

In the embodiment of the present disclosure, the first core network device may be the unified data management (UDM) in the home network HPLMN, and the second core network device may be the authentication server function (AUSF) in the HPLMN.

Alternatively, the first indication information is configured to indicate a UPU capability or a SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

Alternatively, the first indication information may be the UPU ACK transparent container. The first indication information also may be capability information of the terminal and included in the UPU ACK transparent container.

Alternatively, the identifier of the terminal is the SUPI.

In the embodiment of the present disclosure, after receiving the first information, the second core network device may determine whether the first information is encrypted, and determine that the terminal employs a security mechanism for integrity and confidentiality protection in a case that the first information is not encrypted but the first indication information in the first information is encrypted.

Step 1002, a security key K_{AUSF} stored in the second core network device and corresponding to the terminal is determined according to the identifier of the terminal.

In the embodiment of the present disclosure, the second core network device AUSF may determine the security key K_{AUSF} stored in the second core network device and corresponding to the terminal according to the identifier of the terminal.

Alternatively, the identifier of the terminal is the SUPI.

Step 1003, a new integrity check code is generated by using integrity protection algorithm indicated in the second indication information according to the security key K_{AUSF}, UPU counter Counter_{UPU}, and the encrypted first indication information in the first information.

In the embodiment of the present disclosure, the UPU counter is determined by the second core network device, and sent to the terminal for security protection.

In some implementations, the new integrity check code may be generated according to a key derivation function (KDF).

Alternatively, an input parameter KEY of the key derivation function (KDF) for generating the new integrity check code is the security key K_{AUSF}. An input parameter S of the key derivation function (KDF) may include:
a key derivation function code FC;
a parameter P0 indicates the encrypted first indication information;
a parameter L0 indicates a length of data included in the parameter P0, i.e. a length of data of the encrypted first indication information;
a parameter P1 indicates the UPU counter Counter_{UPU}; and
a parameter L1 indicates a length of the UPU counter Counter_{UPU}.

It should be noted that reference can be made to the technical specification (TS) 33.501 of the 3GPP for the definition of the UPU counter Counter_{UPU}.

Step 1004: identity between the new integrity check code and the integrity check code in the first information is determined.

In the embodiment of the present disclosure, after generating the new integrity check code, the second core network device may determine whether the new integrity check code generated by the second core network is identical to the integrity check code in the received first information. If yes, step 1005 is performed, otherwise step 1006 is performed.

Step 1005, the first indication information is sent to the first core network device in a case where the new integrity check code is identical to the integrity check code in the first information.

The first indication information is obtained by decrypting the encrypted first indication information in the first information by using the confidentiality protection algorithm indicated in the second indication information according to the security key K_{AUSF} and the UPU counter Counter_{UPU}.

The confidentiality protection algorithm may be selected and determined by the AUSF according to its own security capability and a security capability of the terminal, and indicated to the terminal through the second indication information.

It should be noted that reference can be made to the algorithm described in the Annex D.1 of the technical specification (TS) 33.501 of the 3GPP for the confidentiality protection algorithm, and reference can be made to the provisions in the Annex D.2 of the technical specification (TS) 33.501 of the 3GPP for the use and operation mode of the confidentiality protection algorithm.

In the embodiment of the present disclosure, in a case where the new integrity check code generated by the second core network device is identical to the integrity check code in the received first information, it indicates that the first information is not tampered and is secure. The second core network device may send the first indication information in the first information to the first core network device. The first core network device may obtain the capability of the terminal according to the first indication information.

Step 1006, an indication procedure of the capability of the terminal is terminated in a case where the new integrity check code is not identical to the integrity check code in the first information.

In the embodiment of the present disclosure, in a case where the new integrity check code generated by the second core network device is not identical to the received integrity check code in the received first information, it indicates that the first information may be tampered and is insecure. The second core network device may terminate the indication procedure of the capability of the terminal.

In conclusion, the first information and the identifier of the terminal that are sent by the first core network device are received, where the first information includes the encrypted first indication information and the integrity check code. The security key K_{AUSF} stored in the second core network device and corresponding to the terminal is determined according to the identifier of the terminal. The new integrity check code is generated according to the K_{AUSF}, the UPU counter Counter_{UPU}, and the encrypted first indication information in the first information. The identity between the new integrity check code and the integrity check code in the first information is determined. The first indication information is sent to the first core network device in a case where the new integrity check code is identical to the integrity check code in the first information. The indication procedure of the capability of the terminal is terminated in a case where the new integrity check code is not identical to the integrity check code in the first information. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

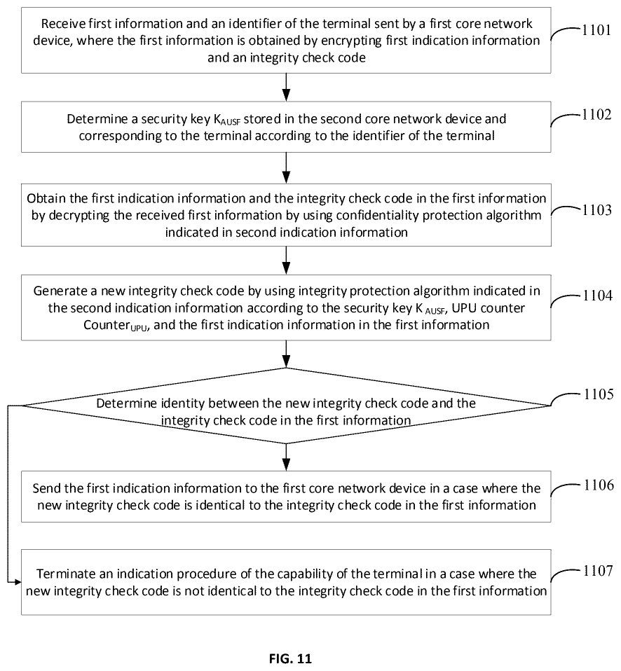

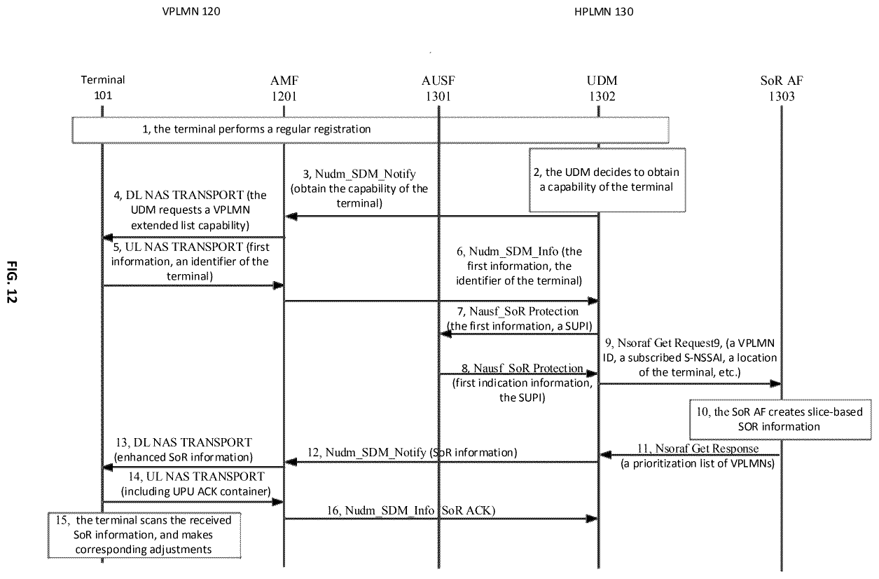

With reference to FIG. 11, FIG. 11 is a schematic flowchart of a method for indicating the capability of the terminal according to an embodiment of the present disclosure. It should be noted that the method for indicating the capability of the terminal according to the embodiment of the present disclosure is performed by a second core network device. The method may be performed alone or in conjunction with any one of the other embodiments of the present disclosure. As shown in FIG. 11, the method may include:

Step 1101: first information and an identifier of the terminal sent by a first core network device are received, where the first information is obtained by encrypting first indication information and an integrity check code.

In the embodiment of the present disclosure, the second core network device may receive the first information and the identifier of the terminal that are sent by the first core network device. The first information is obtained by encrypting the first indication information and the integrity check code, and the first indication information is configured to indicate the capability of the terminal.

It can be understood that the terminal obtains the first information by encrypting the first indication information and the integrity check code by using confidentiality protection algorithm indicated in second indication information according to a security key K_{AUSF} and UPU counter.

The confidentiality protection algorithm may be selected and determined by the AUSF according to its own security capability and a security capability of the terminal, and indicated to the terminal through the second indication information.

It should be noted that reference can be made to the algorithm described in the Annex D.1 of the technical specification (TS) 33.501 of the 3GPP for the confidentiality protection algorithm, and reference can be made to the provisions in the Annex D.2 of the technical specification (TS) 33.501 of the 3GPP for the use and operation mode of the confidentiality protection algorithm.

In the embodiment of the present disclosure, the first core network device may be the unified data management (UDM) in the home network HPLMN, and the second core network device may be the authentication server function (AUSF) in the HPLMN.

Alternatively, the first indication information is configured to indicate the UPU capability or the SoR capability of the terminal.

In the embodiment of the present disclosure, the first indication information may include at least one of the following:
user equipment parameter update (UPU) or steering of roaming (SoR) capability information of the terminal;
location information of the terminal; or
requested network slice selection assistance information (requested-NSSAI) of the terminal.

Alternatively, the first indication information may be UPU ACK transparent container. The first indication information or may be capability information of the terminal and included in the UPU ACK transparent container.

Alternatively, the identifier of the terminal is the SUPI.

In the embodiment of the present disclosure, after receiving the first information, the second core network device may determine whether the first information is encrypted, and determine that the terminal employs a security mechanism for integrity and confidentiality protection in a case that the first information is encrypted.

Step 1102, a security key K_{AUSF} stored in the second core network device and corresponding to the terminal is determined according to the identifier of the terminal.

In the embodiment of the present disclosure, the second core network device AUSF may determine the security key K_{AUSF} stored in the second core network device and corresponding to the terminal according to the identifier of the terminal.

Alternatively, the identifier of the terminal is the SUPI.

Step 1103, the first indication information and the integrity check code in the first information are obtained by decrypting the received first information by using the confidentiality protection algorithm indicated in the second indication information.

In the embodiment of the present disclosure, in a case that the first information received by the second core network device is encrypted, the second core network device may obtain the first indication information and the integrity check code in the first information by decrypting the first information by using the confidentiality protection algorithm determined by the second core network device and indicated to the terminal through the second indication information according to the K_{AUSF} and the UPU counter Counter_{UPU}.

Step 1104, a new integrity check code is generated by using integrity protection algorithm indicated in the second indication information according to the security key K_{AUSF}, UPU counter Counter_{UPU}, and the first indication information in the first information.

In the embodiment of the present disclosure, the UPU counter is determined by the second core network device, and sent to the terminal for security protection.

In the embodiment of the present disclosure, after obtaining the first indication information and the integrity check code in the first information by decrypting the received first information, the second core network device may generate the new integrity check code by using the integrity protection algorithm indicated in the second indication information according to the first indication information obtained by decrypting the first information, the security key K_{AUSF}, and the UPU counter Counter_{UPU}.

In some implementations, the new integrity check code may be generated according to a key derivation function (KDF).

Alternatively, an input parameter KEY of the key derivation function (KDF) for generating the new integrity check code is the security key K_{AUSF}. An input parameter S of the key derivation function (KDF) may include:
a key derivation function code FC;
a parameter P0 indicates the first indication information;
a parameter L0 indicates a length of data included in the parameter P0, i.e. a length of data of the first indication information;
a parameter P1 indicates the UPU counter Counter_{UPU}; and
a parameter L1 indicates a length of the UPU counter Counter_{UPU}.

It should be noted that reference can be made to the technical specification (TS) 33.501 of the 3GPP for the definition of the UPU counter Counter_{UPU}.

Step 1105: identity between the new integrity check code and the integrity check code in the first information is determined.

In the embodiment of the present disclosure, after generating the new integrity check code, the second core network device may determine whether the new integrity check code generated by the second core network is identical to the integrity check code in the received first information. If yes, step 1106 is performed, otherwise step 1107 is performed.

Step 1106, the first indication information is sent to the first core network device in a case where the new integrity check code is identical to the integrity check code in the first information.

In the embodiment of the present disclosure, in a case where the new integrity check code generated by the second core network device is identical to the integrity check code in the decrypted first information, it indicates that the first information is not tampered and is secure. The second core network device may send the first indication information in the first information to the first core network device. The first core network device may obtain the capability of the terminal according to the first indication information.

Step 1107, an indication procedure of the capability of the terminal is terminated in a case where the new integrity check code is not identical to the integrity check code in the first information.

In the embodiment of the present disclosure, in a case where the new integrity check code generated by the second core network device is not identical to the integrity check code in the decrypted first information, it indicates that the first information may be tampered and is insecure. The second core network device may terminate the indication procedure of the capability of the terminal.

In conclusion, the first information and the identifier of the terminal that are sent by the first core network device are received, where the first information is obtained by encrypting the first indication information and the integrity check code. The security key K_{AUSF} stored in the second core network device and corresponding to the terminal is determined according to the identifier of the terminal. The first indication information and the integrity check code in the first information are obtained by decrypting the received first information by using the confidentiality protection algorithm indicated in the second indication information. The new integrity check code is generated according to the security key K_{AUSF}, the UPU counter Counter_{UPU}, and the first indication information in the first information. The identity between the new integrity check code and the integrity check code in the first information is determined. The first indication information is sent to the first core network device in a case where the new integrity check code is identical to the integrity check code in the first information. The indication procedure of the capability of the terminal is terminated in a case where the new integrity check code is not identical to the integrity check code in the first information. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 12, FIG. 12 is a schematic flowchart of a method for indicating the capability of the terminal according to an embodiment of the present disclosure. The method may be performed alone or in conjunction with any one of the other embodiments of the present disclosure. As shown in FIG. 12, the method may include:

1, the terminal 101 performs a regular registration. During that procedure, the UDM 1302 may interact with the SoR AF 1303 to provide SoR information to the terminal 101 during initial registration (for example, provide the SoR information to the terminal 101 based on a local configuration).

2, the UDM 1302 decides to obtain a capability of the terminal 101 to determine whether the terminal 101 supports slice-based SoR information. The UDM 1302 may determine to trigger obtaining of the capability of the terminal 101 based on, for example, the local configuration, a location of the terminal 101 in a specific PLMN, or a new indication provided by the SoR AF 1303 to the UDM 1302 in step 1.

3, the UDM 1302 may trigger an extended UPU procedure and request the terminal 101 to send its UPU capability or SoR capability in a response. Thus, the UDM 1302 sends to the AMF 1201, a Nudm subscriber data management notification (Nudm_SDM_Notify) message including user equipment parameter update (UPU) transparent container (a capability request message) to trigger the terminal 101 to return its UPU capability or SoR capability.

In the technical specification (TS) 33.501 of the 3GPP, the UPU transparent container includes UPU counter Counter_{UPU}, which is configured to protect the integrity of parameter update data of the terminal 101. The Counter_{UPU} is generated by the AUSF 1301.

4, the AMF 1201 sends a downlink non-access stratum transport (DL NAS TRANSPORT) message to the terminal 101. The DL NAS TRANSPORT message includes the UPU transparent container, and the UPU transparent container is configured for the UDM 1302 to request the UPU capability or the SoR capability of the terminal 101 (the capability of the terminal 101 to handle enhanced SoR information, for example, a list of VPLMNs and optional supported network slices and/or applicability information/validity information).

5, the terminal 101 returns its capability within UPU ACK transparent container (first indication information) in a non-access stratum uplink transport (NAS UL TRANSPORT) message to the AMF 1201. The terminal 101 provides integrity protection to the UPU ACK transparent container. The terminal 101 may generate an integrity check code UC-MAC1-I_{UE} by using preset integrity protection algorithm according to a security key K_{AUSF}, the UPU counter Counter_{UPU}, and the UPU ACK transparent container. The UPU ACK transparent container and the integrity check code UC-MAC1-I_{UE} are regarded as a protected container (first information).

It can be understood that the terminal 101 may perform integrity protection to an entire UPU ACK transparent container, or may perform integrity protection to part of information in the UPU ACK transparent container.

It should be noted that the way for the terminal 101 to generate the integrity check code may be implemented through any method in each embodiment of the present disclosure, and is not repeated in the embodiment of the present disclosure here.

6, the AMF 1201 sends, to the UDM 1302, a Nudm subscriber data management information (Nudm_SDM_Info) including the protected container (the first information) indicating the UPU capability or the SoR capability of the terminal 101.

7, the UDM 1302 sends the protected container (the first information) and a subscription permanent identifier (SUPI) of the terminal 101 to the AUSF 1301.

8, the AUSF 1301 leverages the SUPI of the terminal 101 to identify the security key K_{AUSF} corresponding to the terminal 101. In a case that the first information is not encrypted, the AUSF 1301 leverages the security key K_{AUSF} and a local Counter_{UPU} to verify the first information. Specifically, the AUSF 1301 generates a new integrity check code UC-MAC1-I′_{UE} by using preset integrity protection algorithm according to the UPU ACK transparent container (the first indication information) in the first information, the security key K_{AUSF}, and the local Counter_{UPU}; and then checks whether the newly generated integrity check code UC-MAC1-I′_{UE} is identical to an integrity check code UC-MAC1-I_{UE} generated by the terminal 101 in the first information. In a case where the newly generated integrity check code UC-MAC1-I′_{UE} is identical to the integrity check code UC-MAC1-I_{UE}, the AUSF 1301 sends the UPU ACK transparent container (the first indication information) to the UDM 1302. In a case where the newly generated integrity check code UC-MAC1-I′_{UE} is not identical to the integrity check code UC-MAC1-I_{UE}, the AUSF 1301 terminates an indication procedure of the capability.

9, after receiving the UPU ACK transparent container (the first indication information), the UDM 1302 may send a nsoraf steering of roaming get (Nsoraf_SoR_Get) request (a VPLMN identifier (ID), the SUPI of the terminal 101, and an access type (reference can be made to the technical specification (TS) 29.571 of the 3GPP, in which subscribed single network slice selection assistance information (S-NSSAI), the location of the terminal 101, and the capability of the terminal 101 to receive enhanced information are involved) to the SoR AF 1303. The UDM 1302 may also send transparently other information included in the container and relevant to the SoR AF 1303 for consideration by the SoR AF 1303.

10, the SoR AF 1303 creates slice-based SoR information, and takes into account the information provided by the UDM 1302 and availability of the subscribed single network slice selection assistance information (S-NSSAI) in a possible VPLMN 120 simultaneously. In order to create the slice-based SoR information, the SoR AF 1303 scans a list of possible VPLMNs, and for each one determines the extent to which the subscribed NSSAI is supported. Then, the SOR AF 1303 may order the information as follows:
VPLMN 120 supporting all subscribed NSSAI in any order preferred by the HPLMN 130;
VPLMN 120 supporting a subset of the subscribed NSSAI in any order preferred by the HPLMN 130; and
list of additional networks supporting the subscribed NSSAI or requested NSSAI not preferred by the HPLMN 130.

11, the SoR AF 1303 sends the slice-based SoR information to the UDM 1302 in a nsoraf steering of roaming get response (Nsoraf_SoR_Get Response).

12, the UDM 1302 sends, to the AMF 1201, a Nudm notification (Nudm_Notify) and includes the enhanced SoR information.

13, the AMF 1201 sends a downlink non-access stratum transport (DL NAS TRANSPORT) message including the enhanced SoR information to the terminal 101.

Alternatively, an ID of the enhanced SoR information may be included in the message. The terminal 101 stores the enhanced SoR information.

14, the terminal 101 returns UPU ACK in a non-access stratum uplink transport (NAS UL TRANSPORT) message to the AMF 1201.

15, the terminal 101 scans the received steering of roaming (SoR) information and makes corresponding adjustments.

16, the AMF 1201 sends a Nudm subscriber data management information for user equipment parameter update (Nudm_SDM_Info UPU) to the UDM 1302, where SoR ACK is included to acknowledge that the terminal 101 receives the enhanced SoR information (including the list of VPLMNs, etc.).

In conclusion, in the method for indicating the capability of the terminal according to the embodiment of the present disclosure, a protection mechanism (integrity protection) can be provided for the indication procedure of the capability of the terminal. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

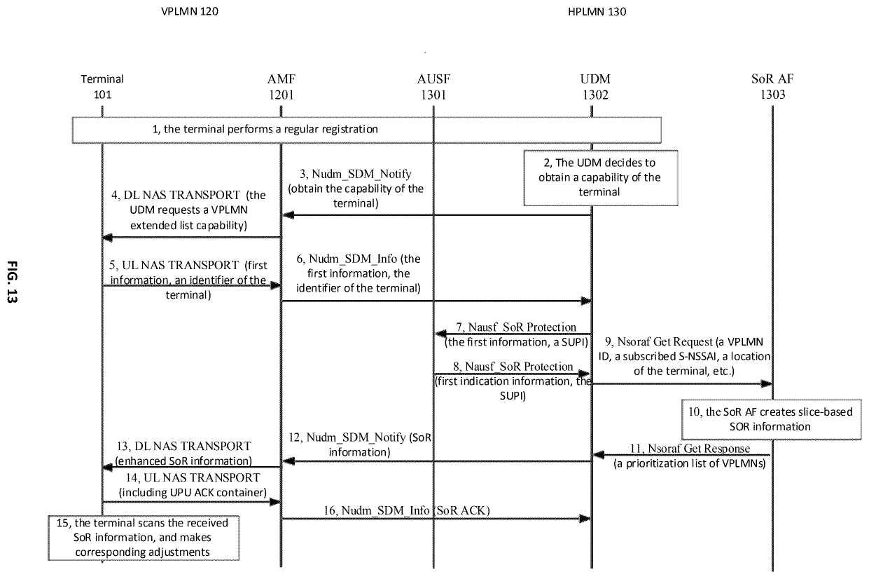

With reference to FIG. 13, FIG. 13 is a schematic flowchart of a method for indicating the capability of the terminal according to an embodiment of the present disclosure. The method may be performed alone or in conjunction with any one of the other embodiments of the present disclosure. As shown in FIG. 13, the method may include:

1, the terminal 101 performs a regular registration. During that procedure, the UDM 1302 may interact with the SoR AF 1303 to provide SoR information to the terminal 101 during initial registration (for example, provide the SoR information to the terminal 101 based on a local configuration).

2, the UDM 1302 decides to obtain the capability of the terminal 101 to determine whether the terminal 101 supports slice-based SoR information. The UDM 1302 may determine to trigger obtaining of the capability of the terminal 101 based on, for example, the local configuration, a location of the terminal 101 in a specific PLMN, or a new indication provided by the SoR AF 1303 to the UDM 1302 in step 1.

3, the UDM 1302 may trigger an extended UPU procedure and request the terminal 101 to send its UPU capability or SoR capability in a response. Thus, the UDM 1302 sends to the AMF 1201, a Nudm subscriber data management notification (Nudm_SDM_Notify) message including user equipment parameter update (UPU) transparent container (a capability request message) to trigger the terminal 101 to return its UPU capability or SoR capability.

In the technical specification (TS) 33.501 of the 3GPP, the UPU transparent container (the capability request message) includes UPU counter Counter_{UPU}, which is configured to protect the integrity of parameter update data of the terminal 101. The Counter_{UPU} is generated by the AUSF 1301. In the UPU transparent container (the capability request message), the AUSF 1301 further indicates security protection algorithm (second indication information) that the terminal 101 needs to use (for example, the algorithm described in the Annex D.1 of the technical specification (TS) 33.501 of the 3GPP). Specifically, the AUSF 1301 may select the security protection algorithm according to its own security capability and a security capability of the terminal 101.

4, the AMF 1201 sends a downlink non-access stratum transport (DL NAS TRANSPORT) message to the terminal 101. The DL NAS TRANSPORT message includes the UPU transparent container, and the UPU transparent container is configured for the UDM 1302 to request the UPU capability or the SoR capability of the terminal 101 (the capability of the terminal 101 to handle enhanced SoR information, for example, a list of VPLMNs and optional supported network slices and/or applicability information/validity information).

5, the terminal 101 returns its capability within UPU ACK transparent container (first indication information) in a non-access stratum uplink transport (NAS UL TRANSPORT) message to the AMF 1201. The terminal 101 provides integrity and confidentiality protection to the UPU ACK transparent container. The terminal 101 encrypts the UPU ACK transparent container by using confidentiality protection algorithm indicated by the AUSF 1301 according to a security key K_{AUSF} and the UPU counter Counter_{UPU}. The terminal 101 generates an integrity check code UC-MAC1-I_{UE} by using integrity protection algorithm indicated by the AUSF 1301 according to the security key K_{AUSF}, the UPU counter Counter_{UPU}, and an encrypted UPU ACK transparent container. The encrypted UPU ACK transparent container and the integrity check code UC-MAC1-I_{UE} are regarded as a protected container (first information).

It can be understood that the terminal 101 may perform integrity and confidentiality protection to an entire UPU ACK transparent container, or may perform integrity and confidentiality protection to part of information in the UPU ACK transparent container.

It should be noted that the way for the terminal 101 to perform encryption and generate the integrity check code may be implemented through any method in each embodiment of the present disclosure, and is not repeated in the embodiment of the present disclosure here.

6, the AMF 1201 sends, to the UDM 1302, a Nudm subscriber data management information (Nudm_SDM_Info) including the protected container (the first information) indicating the UPU capability or the SoR capability of the terminal.

7, the UDM 1302 sends the protected container (the first information) and a subscription permanent identifier (SUPI) of the terminal 101 to the AUSF 1301.

8, the AUSF 1301 leverages the SUPI of the terminal 101 to identify the security key K_{AUSF} corresponding to the terminal 101. In a case that the first information is not encrypted and the UPU ACK transparent container (the first indication information) is encrypted, the AUSF 1301 leverages the security key K_{AUSF} and a local Counter_{UPU} to verify the first information. Specifically, the AUSF 1301 generates a new integrity check code UC-MAC1-I′_{UE} by using the integrity protection algorithm indicated by the AUSF 1301 according to the encrypted UPU ACK transparent container (the first indication information) in the first information, the security key K_{AUSF}, and the local Counter_{UPU}; and then checks whether the newly generated integrity check code UC-MAC1-I′_{UE} is identical to an integrity check code UC-MAC1-I_{UE} generated by the terminal 101 in the first information. In a case where the newly generated integrity check code UC-MAC1-I′_{UE} is identical to the integrity check code UC-MAC1-I_{UE}, the AUSF 1301 decrypts the encrypted UPU ACK transparent container, and sends the decrypted UPU ACK transparent container (the first indication information) to the UDM 1302. In a case where the newly generated integrity check code UC-MAC1-I′_{UE} is not identical to the integrity check code UC-MAC1-I_{UE}, the AUSF 1301 terminates an indication procedure of the capability.

9, after receiving the UPU ACK transparent container (the first indication information), the UDM 1302 may send a nsoraf steering of roaming get (Nsoraf_SoR_Get) request (a VPLMN identifier (ID)), the SUPI of the terminal 101, and an access type (reference can be made to the technical specification (TS) 29.571 of the 3GPP, in which subscribed single network slice selection assistance information (S-NSSAI), the location of the terminal 101, and the capability of the terminal 101 to receive enhanced information are involved) to the SoR AF 1303. The UDM 1302 may also send transparently other information included in the container and relevant to the SoR AF 1303 for consideration by the SoR AF 1303.

10, the SoR AF 1303 creates slice-based SoR information, and takes into account the information provided by the UDM 1302 and availability of the subscribed single network slice selection assistance information (S-NSSAI) in a possible VPLMN 120 simultaneously. In order to create the slice-based SoR information, the SoR AF 1303 scans a list of possible VPLMNs, and for each one determines the extent to which the subscribed NSSAI is supported. Then, the SoR AF 1303 may order the information as follows:
VPLMN 120 supporting all subscribed NSSAI in any order preferred by the HPLMN 130;
VPLMN 120 supporting a subset of the subscribed NSSAI in any order preferred by the HPLMN 130; and
list of additional networks supporting the subscribed NSSAI or requested NSSAI not preferred by the HPLMN 130.

11, the SoR AF 1303 sends the slice-based SoR information to the UDM 1302 in a nsoraf steering of roaming get response (Nsoraf_SoR_Get Response).

12, the UDM 1302 sends, to the AMF 1201, a Nudm notification (Nudm_Notify) and includes the enhanced SoR information.

13, the AMF 1201 sends a downlink non-access stratum transport (DL NAS TRANSPORT) message including the enhanced SoR information to the terminal 101.

Alternatively, an ID of the enhanced SoR information may be included in the message. The terminal 101 stores the enhanced SoR information.

14, the terminal 101 returns UPU ACK in the NAS UL TRANSPORT message to the AMF 1201.

15, the terminal 101 scans the received steering of roaming (SoR) information and makes corresponding adjustments.

16, the AMF 1201 sends a Nudm subscriber data management information for user equipment parameter update (Nudm_SDM_Info UPU) to the UDM 1302, where SoR ACK is included to acknowledge that the terminal 101 receives the enhanced SoR information (including the list of VPLMNs, etc.).

In conclusion, in the method for indicating the capability of the terminal according to the embodiment of the present disclosure, a protection mechanism (for integrity and confidentiality protection) can be provided for the indication procedure of the capability of the terminal. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 14, FIG. 14 is a schematic flowchart of a method for indicating the capability of the terminal according to an embodiment of the present disclosure. The method may be performed alone or in conjunction with any one of the other embodiments of the present disclosure. As shown in FIG. 14, the method may include:

1, the terminal 101 performs a regular registration. During that procedure, the UDM 1302 may interact with the SoR AF 1303 to provide SoR information to the terminal 101 during initial registration (for example, provide the SoR information to the terminal 101 based on a local configuration).

2, the UDM 1302 decides to obtain the capability of the terminal 101 to determine whether the terminal 101 supports slice-based SoR information. The UDM 1302 may determine to trigger obtaining of the capability of the terminal 101 based on, for example, the local configuration, a location of the terminal 101 in a specific PLMN, or a new indication provided by the SoR AF 1303 to the UDM 1302 in step 1.

3, the UDM 1302 may trigger an extended UPU procedure and request the terminal 101 to send its UPU capability or SoR capability in a response. Thus, the UDM 1302 sends to the AMF 1201, a Nudm subscriber data management notification (Nudm_SDM_Notify) message including user equipment parameter update (UPU) transparent container (a capability request message) to trigger the terminal 101 to return its UPU capability or SoR capability.

In the technical specification (TS) 33.501 of the 3GPP, the UPU transparent container (the capability request message) includes UPU counter Counter_{UPU}, which is configured to protect the integrity of parameter update data of the terminal 101. The Counter_{UPU} is generated by the AUSF 1301. In the UPU transparent container (the capability request message), the AUSF 1301 further indicates security protection algorithm (second indication information) that the terminal 101 needs to use (for example, the algorithm described in the Annex D.1 of the technical specification (TS) 33.501 of the 3GPP). Specifically, the AUSF 1301 may select the security protection algorithm according to its own security capability and a security capability of the terminal 101.

4, the AMF 1201 sends a downlink non-access stratum transport (DL NAS TRANSPORT) message to the terminal 101. The DL NAS TRANSPORT message includes the UPU transparent container, and the UPU transparent container is configured for the UDM 1302 to request the UPU capability or the SoR capability of the terminal 101 (the capability of the terminal 101 to handle enhanced SoR information, for example, a list of VPLMNs and optional supported network slices and/or applicability information/validity information).

5, the terminal 101 returns its capability within UPU ACK transparent container (first indication information) in a non-access stratum uplink transport (NAS UL TRANSPORT) message to the AMF 1201. The terminal 101 provides integrity and confidentiality protection to the UPU ACK transparent container. At first, the terminal 101 generates an integrity check code UC-MAC1-I_{UE} by using integrity protection algorithm indicated by the AUSF 1301 according to a security key K_{AUSF}, the UPU counter Counter_{UPU}, and the UPU ACK transparent container. Then, the terminal 101 encrypts the UPU ACK transparent container and the integrity check code UC-MAC1-I_{UE} by using confidentiality protection algorithm indicated by the AUSF 1301 according to the security key K_{AUSF} and the UPU counter Counter_{UPU}. Information obtained by encrypting the UPU ACK transparent container and the integrity check code UC-MAC1-I_{UE} as a whole is regarded as a protected container (first information).

It can be understood that the terminal 101 may perform integrity and confidentiality protection to an entire UPU ACK transparent container, or may perform integrity and confidentiality protection to part of information in the UPU ACK transparent container.

It should be noted that the way for the terminal 101 to perform encryption and generate the integrity check code may be implemented through any method in each embodiment of the present disclosure, and is not repeated in the embodiment of the present disclosure here.

6, the AMF 1201 sends, to the UDM 1302, a Nudm subscriber data management information (Nudm_SDM_Info) including the protected container (the first information) indicating the UPU capability or the SoR capability of the terminal 101.

7, the UDM 1302 sends the protected container (the first information) and a subscription permanent identifier (SUPI) of the terminal 101 to the AUSF 1301.

8, the AUSF 1301 leverages the SUPI of the terminal 101 to identify the security key K_{AUSF} corresponding to the terminal 101. In a case that the first information is encrypted, the AUSF 1301 leverages the security key K_{AUSF} and a local Counter_{UPU} to verify the first information. Specifically, the AUSF 1301 obtains the UPU ACK transparent container (the first indication information) and the integrity check code UC-MAC1-I_{UE} by decrypting the protected container (the first information) by using the confidentiality protection algorithm indicated according to the security key K_{AUSF} and the local Counter_{UPU}. Then, the AUSF 1301 generates a new integrity check code UC-MAC1-I′_{UE} by using the integrity protection algorithm indicated by the AUSF 1301 according to the UPU ACK transparent container (the first indication information) in the first information, the security key K_{AUSF}, and the local Counter_{UPU}; and then checks whether the newly generated integrity check code UC-MAC1-I′_{UE} is identical to an integrity check code (UC-MAC1-I_{UE}) generated by the terminal 101 in the first information. In a case where the newly generated integrity check code UC-MAC1-I′_{UE} is identical to the integrity check code UC-MAC1-I_{UE}, the AUSF 1301 sends the decrypted UPU ACK transparent container (the first indication information) to the UDM 1302. In a case where the newly generated integrity check code UC-MAC1-I′_{UE} is not identical to the integrity check code UC-MAC1-I_{UE}, the AUSF 1301 terminates an indication procedure of the capability.

9, after receiving the UPU ACK transparent container (the first indication information), the UDM 1302 may send a nsoraf steering of roaming get (Nsoraf_SoR_Get) request (a VPLMN identifier (ID)), the SUPI of the terminal 101, and an access type (reference can be made to the technical specification (TS) 29.571 of the 3GPP, in which subscribed single network slice selection assistance information (S-NSSAI), the location of the terminal 101, and the capability of the terminal 101 to receive enhanced information are involved) to the SOR AF 1303. The UDM 1302 may also send transparently other information included in the container and relevant to the SoR AF 1303 for consideration by the SoR AF 1303.

10, the SoR AF 1303 creates slice-based SoR information, and takes into account the information provided by the UDM 1302 and availability of the subscribed single network slice selection assistance information (S-NSSAI) in a possible VPLMN 120 simultaneously. In order to create the slice-based SoR information, the SoR AF 1303 scans a list of possible VPLMNs, and for each one determines the extent to which the subscribed NSSAI is supported. Then, the SOR AF 1303 may order the information as follows:
VPLMN 120 supporting all subscribed NSSAI in any order preferred by the HPLMN 130;
VPLMN 120 supporting a subset of the subscribed NSSAI in any order preferred by the HPLMN 130; and
list of additional networks supporting the subscribed NSSAI or requested NSSAI not preferred by the HPLMN 130.

11, the SoR AF 1303 sends the slice-based SoR information to the UDM 1302 in a nsoraf steering of roaming get response (Nsoraf_SoR_Get Response).

12, the UDM 1302 sends, to the AMF 1201, a Nudm notification (Nudm_Notify) and includes the enhanced SoR information.

13, the AMF 1201 sends a downlink non-access stratum transport (DL NAS TRANSPORT) message including the enhanced SoR information to the terminal 101.

Alternatively, an ID of the enhanced SoR information may be included in the message. The terminal 101 stores the enhanced SoR information.

14, the terminal 101 returns UPU ACK in a non-access stratum uplink transport (NAS UL TRANSPORT) message to the AMF 1201.

15, the terminal 101 scans the received steering of roaming (SoR) information and makes corresponding adjustments.

16, the AMF 1201 sends a Nudm subscriber data management information for user equipment parameter update (Nudm_SDM_Info UPU) to the UDM 1302, where SoR ACK is included to acknowledge that the terminal 101 receives the enhanced SoR information (including the list of VPLMNs, etc.).

In conclusion, in the method for indicating the capability of the terminal according to the embodiment of the present disclosure, a protection mechanism (integrity and confidentiality protection) can be provided for the indication procedure of the capability of the terminal. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

The present disclosure further provides a device for indicating the capability of the terminal, which corresponds to the methods for indicating the capability of the terminal according to several embodiments above. Since the device for indicating the capability of the terminal according to the embodiment of the present disclosure corresponds to the methods according to several embodiments above, the implementations of the methods for indicating the capability of the terminal are also applicable to the device for indicating the capability of the terminal according to the following embodiment, are not repeated in the following embodiment.

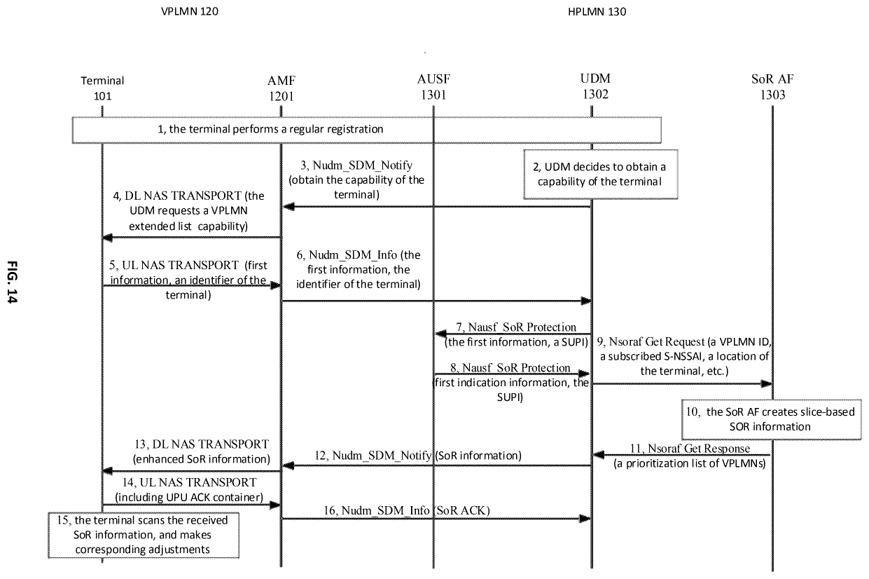

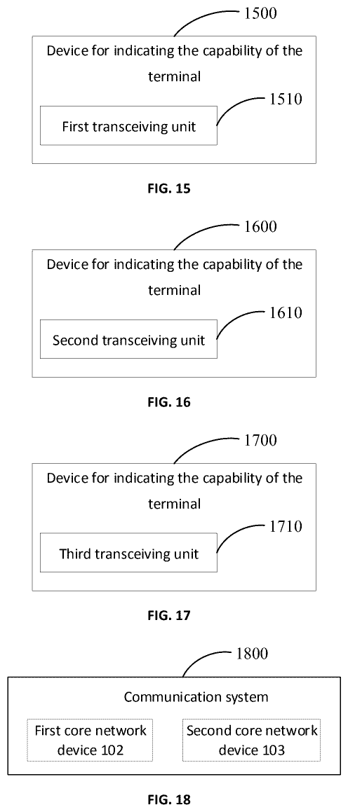

With reference to FIG. 15, FIG. 15 is a schematic structural diagram of a device for indicating a capability of a terminal according to an embodiment of the present disclosure.

As shown in FIG. 15, the device 1500 for indicating the capability of the terminal includes: a first transceiving unit 1510;
the first transceiving unit 1510 is configured to receive a capability request message sent by a first core network device through a visited network.

The first transceiving unit 1510 is further configured to send at least one piece of first information or an identifier of the terminal to the first core network device through the visited network according to the capability request message.

The first information includes first indication information and an integrity check code, and the first indication information is configured to indicate the capability of the terminal.

Alternatively, the capability request message includes at least one of: user equipment parameter update (UPU) counter or second indication information; where the second indication information is configured to indicate security protection algorithm used by the terminal, and the security protection algorithm includes integrity protection algorithm and confidentiality protection algorithm.

Alternatively, in a case where the capability request message includes the UPU counter, the first transceiving unit 1510 is specifically configured to generate, by using the integrity protection algorithm, the integrity check code, according to a security key K_{AUSF} corresponding to the terminal, the UPU counter, and the first indication information; and send the first information to the first core network device through the visited network, where the first information includes the first indication information and the integrity check code.

Alternatively, in a case where the capability request message includes the UPU counter and the second indication information, according to the capability request message, the first transceiving unit 1510 is specifically configured to generate, by using the integrity protection algorithm indicated in the second indication information, the integrity check code, according to a security key K_{AUSF} corresponding to the terminal, the UPU counter, and the first indication information; and send the first information to the first core network device through the visited network, where the first information includes the first indication information and the integrity check code.

Alternatively, in a case where the capability request message includes the UPU counter and the second indication information, the first transceiving unit 1510 is specifically configured to obtain encrypted first indication information by encrypting the first indication information by using the confidentiality protection algorithm indicated in the second indication information according to a security key K_{AUSF} corresponding to the terminal and the UPU counter; generate, by using the integrity protection algorithm indicated in the second indication information, the integrity check code, according to the security key K_{AUSF}, the UPU counter, and the encrypted first indication information; and send the first information to the first core network device through the visited network, where the first information includes the encrypted first indication information and the integrity check code.

Alternatively, in a case where the first indication information employs a security mechanism for integrity and confidentiality protection, the first transceiving unit 1510 is specifically configured to generate, by using the integrity protection algorithm indicated in the second indication information, the integrity check code, according to a security key K_{AUSF} corresponding to the terminal, the UPU counter, and the first indication information; obtain the first information by encrypting the first information and the integrity check code by using the confidentiality protection algorithm indicated in the second indication information according to the security key K_{AUSF} and the UPU counter; and

send the first information to the first core network device through the visited network.

Alternatively, the first core network device is the unified data management (UDM).

Alternatively, the first indication information includes at least one of the following: user equipment parameter update (UPU) or steering of roaming (SoR) capability information of the terminal; location information of the terminal; or requested network slice selection assistance information (requested-NSSAI) of the terminal.

In the device for indicating the capability of the terminal according to the embodiment, the capability request message sent by the first core network device of the home network through the visited network may be received. The first information and the identifier of the terminal may be sent to the first core network device through the visited network according to the capability request message. The first information includes the first indication information and the integrity check code, and the first indication information is configured to indicate the capability of the terminal. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 16, FIG. 16 is a schematic structural diagram of a device for indicating the capability of the terminal according to an embodiment of the present disclosure.

As shown in FIG. 16, the device 1600 for indicating the capability of the terminal includes: a second transceiving unit 1610; where the second transceiving unit 1610 is configured to send a capability request message to the terminal through the visited network, where the capability request message is configured to request the terminal to indicate the capability of the terminal.

The second transceiving unit 1610 is further configured to receive at least one piece of first information or an identifier of the terminal sent by the terminal through the visited network.

The first information includes first indication information and an integrity check code, and the first indication information is configured to indicate the capability of the terminal.

Alternatively, the second transceiving unit 1610 is further configured to receive at least one of user equipment parameter update (UPU) counter or second indication information sent by a second core network device; where the second indication information is configured to indicate security protection algorithm used by the terminal, and the security protection algorithm includes integrity protection algorithm and confidentiality protection algorithm.

The capability request message includes at least one of the user equipment parameter update (UPU) counter or the second indication information.

Alternatively, in a case where the capability request message includes the user equipment parameter update (UPU) counter, the second transceiving unit 1610 is specifically configured to receive the first information sent by the terminal through the visited network; where the first information includes the first indication information and the integrity check code; and the integrity check code is generated by using the integrity protection algorithm according to a security key K_{AUSF} corresponding to the terminal, the UPU counter, and the first indication information.

Alternatively, in a case where the capability request message includes the user equipment parameter update (UPU) counter and the second indication information, the second transceiving unit 1610 is specifically configured to receive the first information sent by the terminal through the visited network; where the first information includes the first indication information and the integrity check code; and the integrity check code is generated by using the integrity protection algorithm indicated in the second indication information according to a security key K_{AUSF} corresponding to the terminal, the UPU counter, and the first indication information.

Alternatively, in a case where the capability request message includes the user equipment parameter update (UPU) counter and the second indication information, the second transceiving unit 1610 is specifically configured to receive the first information sent by the terminal through the visited network; where the first information includes encrypted first indication information and the integrity check code; the encrypted first indication information is obtained by encrypting the first indication information by using the confidentiality protection algorithm indicated in the second indication information according to a security key K_{AUSF} corresponding to the terminal and the UPU counter; and the integrity check code is generated by using the integrity protection algorithm indicated in the second indication information according to the security key K_{AUSF}, the UPU counter, and the encrypted first indication information.

Alternatively, in a case where the capability request message includes the user equipment parameter update (UPU) counter and the second indication information, the second transceiving unit 1610 is specifically configured to receive the first information sent by the terminal through the visited network; where the first information is obtained by encrypting the first indication information and the integrity check code by using the confidentiality protection algorithm indicated in the second indication information according to a security key K_{AUSF} corresponding to the terminal and the UPU counter; and the integrity check code is generated by using the integrity protection algorithm indicated in the second indication information according to the security key K_{AUSF}, the UPU counter, and the first indication information.

Alternatively, the second transceiving unit 1610 is further configured to send at least one piece of the first information or the identifier of the terminal to the second core network device; where the integrity check code is configured for the second core network device to verify whether the first indication information is tampered.

Alternatively, the second transceiving unit 1610 is further configured to receive the verified first indication information sent by the second core network device.

Alternatively, the first core network device is the unified data management (UDM), and the second core network device is the authentication server function (AUSF).

Alternatively, the first indication information includes at least one of the following: user equipment parameter update (UPU) or steering of roaming (SoR) capability information of the terminal; location information of the terminal; or requested network slice selection assistance information (requested-NSSAI) of the terminal.

In the device for indicating the capability of the terminal according to the embodiment, the capability request message may be sent to the terminal through the visited network, where the capability request message is configured to request the terminal to indicate the capability of the terminal. The first information sent by the terminal through the visited network may be received. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 17, FIG. 17 is a schematic structural diagram of a device for indicating the capability of the terminal according to an embodiment of the present disclosure.

As shown in FIG. 17, the device 1700 for indicating the capability of the terminal includes: a third transceiving unit 1710; where
a third transceiving unit 1710 is configured to receive first information and an identifier of the terminal sent by a first core network device.

The first information includes first indication information and an integrity check code, and the first indication information is configured to indicate the capability of the terminal.

Alternatively, the third transceiving unit 1710 is further configured to send at least one of user equipment parameter update (UPU) counter or second indication information to the first core network device; where the second indication information is configured to indicate security protection algorithm used by the terminal, and the security protection algorithm includes integrity protection algorithm and confidentiality protection algorithm.

Alternatively, in a case where the first information includes the first indication information and the integrity check code, the device further includes a processing unit (not shown in the figure). The processing unit is configured to determine a security key K_{AUSF} stored in the second core network device and corresponding to the terminal according to the identifier of the terminal; generate a new integrity check code by using the integrity protection algorithm according to the security key K_{AUSF}, the UPU counter, and the first indication information in the first information; and determine identity between the new integrity check code and the integrity check code in the first information.

Alternatively, the third transceiving unit 1710 is further configured to send the first indication information to the first core network device in a case where the new integrity check code is identical to the integrity check code in the first information; and terminate an indication procedure of the capability of the terminal in a case where the new integrity check code is not identical to the integrity check code in the first information.

Alternatively, in a case where the first information includes the first indication information and the integrity check code, the device further includes a processing unit (not shown in the figure). The processing unit is configured to determine a security key K_{AUSF} stored in the second core network device and corresponding to the terminal according to the identifier of the terminal; generate a new integrity check code by using the integrity protection algorithm indicated in the second indication information according to the security key K_{AUSF}, the UPU counter, and the first indication information in the first information; and determine identity between the new integrity check code and the integrity check code in the first information.

Alternatively, the third transceiving unit 1710 is further configured to send the first indication information to the first core network device in a case where the new integrity check code is identical to the integrity check code in the first information; and terminate an indication procedure of the capability of the terminal in a case where the new integrity check code is not identical to the integrity check code in the first information.

Alternatively, in a case where the first information includes encrypted first indication information and the integrity check code, the device further includes a processing unit (not shown in the figure). The processing unit is configured to determine a security key K_{AUSF} stored in the second core network device and corresponding to the terminal according to the identifier of the terminal; generate a new integrity check code by using the integrity protection algorithm indicated in the second indication information according to the security key K_{AUSF}, the UPU counter, and the encrypted first indication information in the first information; and determine identity between the new integrity check code and the integrity check code in the first information.

Alternatively, the third transceiving unit 1710 is further configured to send the first indication information to the first core network device in a case where the new integrity check code is identical to the integrity check code in the first information; where the first indication information is obtained by decrypting the encrypted first indication information by using the confidentiality protection algorithm indicated in the second indication information according to the security key K_{AUSF} and the UPU counter; and terminate an indication procedure of the capability of the terminal in a case where the new integrity check code is not identical to the integrity check code in the first information.

Alternatively, in a case where the first information is obtained by encrypting the first indication information and the integrity check code, the device further includes a processing unit (not shown in the figure). The processing unit is configured to determine a security key K_{AUSF} stored in the second core network device and corresponding to the terminal according to the identifier of the terminal; obtain the first indication information and the integrity check code in the first information by decrypting the first information by using the confidentiality protection algorithm indicated in the second indication information according to the security key K_{AUSF} and the UPU counter; generate a new integrity check code by using the integrity protection algorithm indicated in the second indication information according to the security key K_{AUSF}, the UPU counter, and the first indication information in the first information; and determine identity between the new integrity check code and the integrity check code in the first information.

Alternatively, the third transceiving unit 1710 is further configured to send the first indication information to the first core network device in a case where the new integrity check code is identical to the integrity check code in the first information; and terminate an indication procedure of the capability of the terminal in a case where the new integrity check code is not identical to the integrity check code in the first information.

Alternatively, the first core network device is the unified data management (UDM), and the second core network device is the authentication server function (AUSF).

Alternatively, the first indication information includes at least one of the following: user equipment parameter update (UPU) or steering of roaming (SoR) capability information of the terminal; location information of the terminal; or requested network slice selection assistance information (requested-NSSAI) of the terminal.

In the device for indicating the capability of the terminal according to the embodiment, the first information and the identifier of the terminal sent by the first core network device may be received. Whether the first information is tampered may be verified according to the integrity check code in the first information. Thus, the terminal can resist sniffing, removing, or tampering by the visited network on the information sent by the terminal, and securely indicate its own capability information to the home network. Accordingly, security of information interaction between the terminal and the home network is protected, and security of the system is improved.

With reference to FIG. 18, FIG. 18 is a schematic diagram of a communication system 1800 according to an embodiment of the present disclosure.

As shown in FIG. 18, the communication system 1800 includes: a first core network device 102 and a second core network device 103.

The second core network device 103 is configured to send at least one of user equipment parameter update (UPU) counter or second indication information to the first core network device 102.

The first core network device 102 is configured to receive at least one of the UPU counter or the second indication information; and send a capability request message to a terminal through the visited network; where the capability request message is configured to request the terminal to indicate a capability of the terminal, and the capability request message includes at least one of the UPU counter or the second indication information.

The first core network device 102 is further configured to receive first information and an identifier of the terminal that are sent by the terminal through the visited network; and send the first information to the second core network device.

The second core network device 103 is further configured to receive the first information and the identifier of the terminal, and verify the first information; and send first indication information in the verified first information to the first core network device.

Alternatively, the first indication information includes at least one of the following:
user equipment parameter update (UPU) or steering of roaming (SoR) capability information of the terminal;
location information of the terminal; or
requested network slice selection assistance information (requested-NSSAI) of the terminal.

Alternatively, the second indication information is configured to indicate security protection algorithm used by the terminal, and the security protection algorithm includes integrity protection algorithm and confidentiality protection algorithm.

In order to implement the above embodiments, a communication device is further provided in the embodiments of the present disclosure. The communication device includes a processor and a memory that stores a computer program; where the computer program, when executed by the processor, causes the communication device to perform the method in the embodiments shown in FIGS. 2 to 5.

In order to implement the above embodiments, a communication device is further provided in the embodiments of the present disclosure. The communication device includes a processor and a memory that stores a computer program; where the computer program, when executed by the processor, causes the communication device to perform the method in the embodiments shown in FIGS. 6 to 7 or the methods in the embodiments shown in FIGS. 8 to 11.

In order to implement the above embodiments, a communication device is further provided in the embodiments of the present disclosure. The communication device includes a processor and an inference circuit; where the interface circuit is configured to receive code instructions, and transmit the code instructions to the processor, and the processor, when executing the code instructions, is configured to perform the methods in the embodiments shown in FIGS. 2 to 5.

In order to implement the above embodiments, a communication device is further provided in the embodiments of the present disclosure. The communication device includes a processor and an inference circuit; where the interface circuit is configured to receive code instructions, and transmit the code instructions to the processor, and the processor, when executing the code instructions, is configured to perform the methods in the embodiments shown in FIGS. 6 to 7 or the methods in the embodiments shown in FIGS. 8-11.

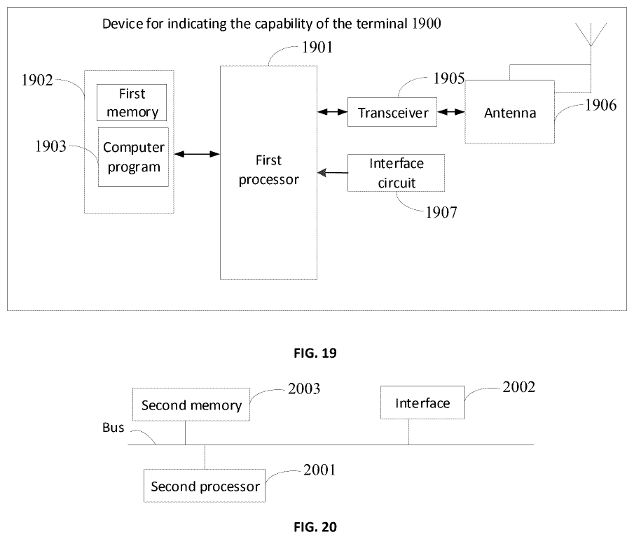

With reference to FIG. 19, FIG. 19 is a schematic structural diagram of a device for indicating the capability of the terminal according to an embodiment of the present disclosure. The device 1900 for indicating the capability of the terminal may be a network device; a terminal; a chip, chip system, or processor that supports a network device to implement the above method; or a chip, chip system, or processor that supports a terminal to implement the above method. The device may be configured to implement the method described in the above method embodiment, and reference can be made to the description in the above method embodiment for details.

The device 1900 for indicating a capability of a terminal may include one or more first processors 1901. The first processor 1901 may be a general-purpose processor, a special-purpose processor, etc. For example, the processor may be a baseband processor or a central processing unit. The baseband processor may be configured to process communication protocols and communication data. The central processing unit may be configured to control the device for indicating a capability of a terminal (such as a base station, a baseband chip, the terminal, a terminal chip, a distributed unit (DU), and a centralized unit (CU)), execute a computer program, and process data of the computer program.

Alternatively, the device 1900 for indicating the capability of the terminal may further include one or more first memories 1902; where the memory stores a computer program 1903, and the computer program 1903, when executed by the first processor 1901, causes the device 1900 for indicating the capability of the terminal to perform the method described in the above method embodiment. The computer program 1903 may be firmed in the first processor 1901. In this case, the first processor 1901 may be implemented by hardware.

Alternatively, the first memory 1902 may also store data. The device 1900 for indicating the capability of the terminal and the first memory 1902 may be configured separately or integrated together.

Alternatively, the device 1900 for indicating the capability of the terminal may further include a transceiver 1905 and an antenna 1906. The transceiver 1905 may be referred to as a transceiving unit, a transceiving machine, a transceiving circuit, etc., and is configured to implement a function of transceiving. The transceiver 1905 may include a receiver and a transmitter; where the receiver may be referred to as a reception machine, a reception circuit, etc., and is configured to implement a function of reception; and the transmitter may be referred to as a transmission machine, a transmission circuit, etc., and is configured to implement a function of transmission.

Alternatively, the device 1900 for indicating the capability of the terminal may further include one or more interface circuits 1907. The interface circuit 1907 is configured to receive code instructions, and transmit the code instructions to the first processor 1901. The code instructions, when executed by the first processor 1901, cause the device 1900 for indicating the capability of the terminal to perform the method described in the above method embodiment.

In an implementation, the first processor 1901 may include a transceiver configured to implement functions of reception and transmission. For example, the transceiver may be a transceiving circuit, an interface, or an interface circuit. The transceiving circuit, interface, or interface circuit configured to implement the functions of reception and transmission may be separated or integrated together. The above transceiving circuit, interface, or interface circuit may be configured to read and write codes/data. Alternatively, the above transceiving circuit, interface, or interface circuit may be configured to transmit or transfer a signal.

In an implementation, the device 1900 for indicating the capability of the terminal may include a circuit, where the circuit may implement a function of transmission, reception, or communication in the foregoing method embodiment. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver or may be fabricated through various IC process technologies, such as a complementary metal oxide semiconductor (CMOS), a metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The device for indicating the capability of the terminal described in the above embodiment may be the network device or the terminal, but which does not limit the scope of the device for indicating the capability of the terminal described in the present disclosure. The structure of the device for indicating the capability of the terminal may not be limited by FIGS. 15 to 17. The device for indicating the capability of the terminal may be a stand-alone device or a part of a large device. For example, the device for indicating the capability of the terminal may be:
(1) an independent integrated circuit (IC), a chip, a chip system, or a chip sub-system;
(2) a set having one or more ICs, which may alternatively include a storage component configured to store data and computer programs;
(3) an ASIC, such as a modem;
(4) a module, which may be embedded in other devices;
(5) a receiver, a terminal, a smart terminal, a cellular phone, a radio device, a handset, a mobile unit, a vehicle-mounted device, a network device, a cloud device, an artificial intelligence device, etc.; and
(6) other devices, etc.

Reference can be made to the schematic structural diagram of a chip shown in FIG. 20 for the case where the device for indicating the capability of the terminal may be the chip or the chip system. The chip shown in FIG. 20 includes a second processor 2001 and an interface 2002. One or more second processors 2001 may be provided, and a plurality of interfaces 2002 may be provided.

In a case that the chip is configured to implement the functions of the network device in the embodiment of the present disclosure:
the interface 2002 is configured to receive code instructions, and transmit the code instructions to the processor; and
the second processor 2001 is configured to perform the methods in FIGS. 6 to 7 or the methods in FIGS. 8 to 11 by running the code instruction.

In a case that the chip is configured to implement the functions of the terminal in the embodiment of the present disclosure:
the interface 2002 is configured to receive code instructions, and transmit the code instructions to the processor; and
the second processor 2001 is configured to perform the methods in FIGS. 2 to 5 by running the code instructions.

Alternatively, the chip further includes a second memory 2003, where the second memory 2003 is configured to store the necessary computer program and data.

Those skilled in the art can also appreciate that various illustrative logical blocks and steps set forth in the embodiments of the present disclosure can be implemented through electronic hardware, computer software, or their combinations. Whether such functions are implemented through the hardware or the software depends on the specific application and overall system design requirements. Those skilled in the art can implement the functions through various methods for each particular application, but such an implementation should not be interpreted as falling beyond the scope of protection of the embodiments of the present disclosure.

A communication system is further provided in the embodiments of the present disclosure. The system includes the device for indicating the capability of the terminal in the foregoing embodiments in FIGS. 15 to 17 serving as the terminal. Alternatively, the system includes the device for indicating the capability of the terminal in the foregoing embodiment in FIG. 19 serving as the terminal.

The present disclosure further provides a non-transitory readable storage medium storing, where the instructions, when executed by a computer, implement the functions in any method embodiment above.

The present disclosure further provides a computer program product. When performed by a computer, the computer program product implements the functions in any method embodiment above.

In the above embodiment, some or all of the functions may be implemented through software, hardware, firmware, or their any combinations. When implemented through the software, some or all of the functions may be implemented in a form of the computer program product. The computer program product includes one or more computer programs. When loaded and executed on the computer, some or all of the computer programs generate the flows or functions according to the embodiment of the present disclosure. The computer can be a general-purpose computer, a special-purpose computer, a computer network, or another programmable device. The computer program can be stored in a non-transitory computer-readable storage medium, or transmitted from one non-transitory computer-readable storage medium to another non-transitory computer-readable storage medium, for example, from one website, computer, server, or data center to another website, computer, server, or data center through a wired means (for example, a coaxial cable, an optical fiber, and a digital subscriber line (DSL)), or a wireless means (for example, infrared, radio waves, and microwaves). The non-transitory computer-readable storage medium can be any available medium that the computer can access, or an integrated server, data center, etc. encompassing one or more available media. The available medium can be a magnetic medium (for example, a floppy disk, a hard disk, or a tape), an optical medium (for example, a digital video disk (DVD)), a semiconductor medium (for example, a solid state disk (SSD)), etc.

Those of ordinary skill in the art can understand that various numerical numbers such as first and second involved in the present disclosure are merely for convenience of description, instead of limiting the scope of the embodiments of the present disclosure, and also indicate a successive sequence.

At least one of in the present disclosure can also be described as one or more, and a plurality of can indicate two, three, four, or more, which is not limited in the present disclosure. In the embodiments of the present disclosure, technical features in a kind of technical features are distinguished by “first”, “second”, “third”, “A”, “B”, “C”, and “D”, and there is no successive sequence or magnitude sequence among the technical features described by “first”, “second”, “third”, “A”, “B”, “C”, and “D”.

Correspondence relations shown in each table of the present disclosure can be configured or pre-defined. Values of information in each table are merely illustrative, and can be configured as other values, which are not limited in the present disclosure. When a correspondence relation between the information and each parameter is configured, it is not necessarily required to configure all the correspondence relations indicated in each table. For example, in the table of the present disclosure, the corresponding relations shown in some rows may not be configured. For another example, appropriate deformation and adjustment, such as splitting and merging, can be made based on the above table. The name of the parameter shown in the title of each table can also employ other names that are understandable by the communication device, and the value or expression mode of the parameter can also employ other values or expression modes that are understandable by the communication device. When implemented, each table can also employ other data structures, such as an array, a queue, a container, a stack, a linear table, a pointer, a linked list, a tree, a graph, a structural body, a class, a heap, and a hash table.

Pre-defining in the present disclosure can be interpreted as defining, pre-defining, storing, pre-storing, pre-negotiating, pre-configuring, firming, or pre-firing.

Those of ordinary skill in the art can appreciate that the units and algorithm steps of all instances described in combination with the embodiments disclosed here can be implemented through electronic hardware, or combinations of computer software and electronic hardware. Whether these functions are executed through hardware or software depends on the particular application of the technical solution and design constraint conditions. Those skilled in the art can implement the functions described through different methods for each particular application, but such an implementation should not be regarded as falling beyond the scope of the present disclosure.

Those skilled in the art can clearly understand that for convenience and brevity of description, reference can be made to the corresponding processes in the foregoing method embodiment for specific operating processes of the above system, device, and unit, which will not be repeated here.

It should be understood that various forms of the flows shown above can be used, with steps re-ranked, added, or removed. For example, as long as the desired results of the technical solutions disclosed in the present disclosure can be realized, various steps described in the embodiments of the present disclosure can be executed in parallel, in sequence, or in different orders, which is not limited here.

The above particular implementations are not intended to limit the scope of protection of the present disclosure. Those skilled in the art should understand that various modifications, combinations, sub-combinations, and substitutions can be made according to the design requirements, etc. Any modifications, equivalent replacements, improvements, etc. made within the spirit and principles of the present disclosure should fall within the scope of protection of the present disclosure.

1. A method for indicating a capability of a terminal, performed by the terminal, the method comprising:
receiving a capability request message sent by a first core network device through a visited network; and
sending at least one piece of first information or an identifier of the terminal to the first core network device through the visited network according to the capability request message;
wherein the first information comprises first indication information and an integrity check code, and the first indication information is configured to indicate the capability of the terminal.

2. The method according to claim 1, wherein the capability request message comprises at least one of user equipment parameter update (UPU) counter or second indication information; and
the second indication information is configured to indicate security protection algorithm used by the terminal, and the security protection algorithm comprises integrity protection algorithm and confidentiality protection algorithm.

3. The method according to claim 2, wherein in a case where the capability request message comprises the UPU counter, sending the first information to the first core network device through the visited network according to the capability request message comprises:
generating, by using the integrity protection algorithm, the integrity check code, according to a security key K_{AUSF} corresponding to the terminal, the UPU counter and the first indication information; and
sending the first information to the first core network device through the visited network, wherein the first information comprises the first indication information and the integrity check code; or
wherein in a case where the capability request message comprises the UPU counter and the second indication information, sending the first information to the first core network device through the visited network according to the capability request message comprises:
generating, by using the integrity protection algorithm indicated in the second indication information, the integrity check code, according to a security key K_{AUSF} corresponding to the terminal, the UPU counter, and the first indication information; and
sending the first information to the first core network device through the visited network, wherein the first information comprises the first indication information and the integrity check code; or
wherein in a case where the capability request message comprises the UPU counter and the second indication information, sending the first information to the first core network device through the visited network according to the capability request message comprises:
obtaining encrypted first indication information by encrypting the first indication information by using the confidentiality protection algorithm indicated in the second indication information according to a security key K_{AUSF} corresponding to the terminal and the UPU counter;
generating, by using the integrity protection algorithm indicated in the second indication information, the integrity check code, according to the security key K_{AUSF}, the UPU counter, and the encrypted first indication information; and
sending the first information to the first core network device through the visited network, wherein the first information comprises the encrypted first indication information and the integrity check code.

4-5. (canceled)

6. The method according to claim 2, wherein in a case where the first indication information employs a security mechanism for integrity and confidentiality protection, sending the first information to the first core network device through the visited network according to the capability request message comprises:
generating, by using the integrity protection algorithm indicated in the second indication information, the integrity check code, according to a security key K_{AUSF} corresponding to the terminal, the UPU counter, and the first indication information; and
obtaining the first information by encrypting the first indication information and the integrity check code by using the confidentiality protection algorithm indicated in the second indication information according to the security key K_{AUSF} and the UPU counter; and
sending the first information to the first core network device through the visited network.

7. (canceled)

8. The method according to claim 1, wherein the first indication information comprises at least one of the following:
user equipment parameter update (UPU) or steering of roaming (SoR) capability information of the terminal;
location information of the terminal; or
requested network slice selection assistance information (requested-NSSAI) of the terminal.

9. A method for indicating a capability of a terminal, performed by a first core network device, the method comprising:
sending a capability request message to the terminal through a visited network, wherein the capability request message is configured to request the terminal to indicate the capability of the terminal; and
receiving at least one piece of first information or an identifier of the terminal sent by the terminal through the visited network;
wherein the first information comprises first indication information and an integrity check code, and the first indication information is configured to indicate the capability of the terminal.

10. The method according to claim 9, further comprising:
receiving at least one of user equipment parameter update (UPU) counter or second indication information sent by a second core network device; wherein the second indication information is configured to indicate security protection algorithm used by the terminal, and the security protection algorithm comprises integrity protection algorithm and confidentiality protection algorithm; and
the capability request message comprises at least one of the user equipment parameter update (UPU) counter or the second indication information.

11. The method according to claim 10, wherein in a case where the capability request message comprises the user equipment parameter update (UPU) counter, receiving the first information sent by the terminal through the visited network comprises:
receiving the first information sent by the terminal through the visited network; wherein the first information comprises the first indication information and the integrity check code; and
the integrity check code is generated by using the integrity protection algorithm according to a security key K_{AUSF} corresponding to the terminal, the UPU counter, and the first indication information; or
wherein in a case where the capability request message comprises the user equipment parameter update (UPU) counter and the second indication information, receiving the first information sent by the terminal through the visited network comprises:
receiving the first information sent by the terminal through the visited network; wherein the first information comprises the first indication information and the integrity check code; and
wherein the integrity check code is generated by using the integrity protection algorithm indicated in the second indication information according to a security key K_{AUSF} corresponding to the terminal, the UPU counter, and the first indication information.

12. (canceled)

13. The method according to claim 10, wherein in a case where the capability request message comprises the user equipment parameter update (UPU) counter and the second indication information, receiving the first information sent by the terminal through the visited network comprises:
receiving the first information sent by the terminal through the visited network; wherein the first information comprises encrypted first indication information and the integrity check code;
wherein the encrypted first indication information is obtained by encrypting the first indication information by using the confidentiality protection algorithm indicated in the second indication information according to a security key K_{AUSF} corresponding to the terminal and the UPU counter; and the integrity check code is generated by using the integrity protection algorithm indicated in the second indication information according to the security key K_{AUSF}, the UPU counter, and the encrypted first indication information; or
wherein in a case where the capability request message comprises the user equipment parameter update (UPU) counter and the second indication information, receiving the first information sent by the terminal through the visited network comprises:
receiving the first information sent by the terminal through the visited network;
wherein the first information is obtained by encrypting the first indication information and the integrity check code by using the confidentiality protection algorithm indicated in the second indication information according to a security key K_{AUSF} corresponding to the terminal and the UPU counter; and the integrity check code is generated by using the integrity protection algorithm indicated in the second indication information according to the security key K_{AUSF}, the UPU counter, and the first indication information.

14. (canceled)

15. The method according to claim 11, further comprising:
sending at least one piece of the first information or the identifier of the terminal to the second core network device; wherein the integrity check code is configured for the second core network device to verify whether the first indication information is tampered.

16. The method according to claim 15, further comprising:
receiving the verified first indication information sent by the second core network device.

17-18. (canceled)

19. A method for indicating a capability of a terminal, performed by a second core network device, the method comprising:
receiving at least one piece of first information or an identifier of the terminal sent by a first core network device; wherein the first information comprises first indication information and an integrity check code, and the first indication information is configured to indicate the capability of the terminal.

20. The method according to claim 19, further comprising:
sending at least one of user equipment parameter update (UPU) counter or second indication information to the first core network device; wherein the second indication information is configured to indicate security protection algorithm used by the terminal, and the security protection algorithm comprises integrity protection algorithm and confidentiality protection algorithm.

21. The method according to claim 20, wherein in a case where the first information comprises the first indication information and the integrity check code, the method further comprises:
determining a security key K_{AUSF} stored in the second core network device and corresponding to the terminal according to the identifier of the terminal;
generating a new integrity check code by using the integrity protection algorithm according to the security key K_{AUSF}, the UPU counter, and the first indication information in the first information; and
determining identity between the new integrity check code and the integrity check code in the first information; or
wherein in a case where the first information comprises the first indication information and the integrity check code, the method further comprises:
determining a security key K_{AUSF} stored in the second core network device and corresponding to the terminal according to the identifier of the terminal;
generating a new integrity check code by using the integrity protection algorithm indicated in the second indication information according to the security key K_{AUSF}, the UPU counter, and the first indication information in the first information; and
determining identity between the new integrity check code and the integrity check code in the first information.

22. The method according to claim 21, further comprising:
sending the first indication information to the first core network device in a case where the new integrity check code is identical to the integrity check code in the first information; and
terminating an indication procedure of the capability of the terminal in a case where the new integrity check code is not identical to the integrity check code in the first information.

23-24. (canceled)

25. The method according to claim 20, wherein in a case where the first information comprises encrypted first indication information and the integrity check code, the method further comprises:
determining a security key K_{AUSF} stored in the second core network device and corresponding to the terminal according to the identifier of the terminal;
generating a new integrity check code by using the integrity protection algorithm indicated in the second indication information according to the security key K_{AUSF}, the UPU counter, and the encrypted first indication information in the first information; and
determining identity between the new integrity check code and the integrity check code in the first information.

26. The method according to claim 25, further comprising:
sending the first indication information to the first core network device in a case where the new integrity check code is identical to the integrity check code in the first information; wherein the first indication information is obtained by decrypting the encrypted first indication information by using the confidentiality protection algorithm indicated in the second indication information according to the security key K_{AUSF} and the UPU counter; and
terminating an indication procedure of the capability of the terminal in a case where the new integrity check code is not identical to the integrity check code in the first information.

27. The method according to claim 20, wherein in a case where the first information is obtained by encrypting the first indication information and the integrity check code, the method further comprises:
determining a security key K_{AUSF} stored in the second core network device and corresponding to the terminal according to the identifier of the terminal;
obtaining the first indication information and the integrity check code in the first information by decrypting the first information by using the confidentiality protection algorithm indicated in the second indication information according to the security key K_{AUSF} and the UPU counter;
generating a new integrity check code by using the integrity protection algorithm indicated in the second indication information according to the security key K_{AUSF}, the UPU counter, and the first indication information in the first information; and
determining identity between the new integrity check code and the integrity check code in the first information.

28. The method according to claim 27, further comprising:
sending the first indication information to the first core network device in a case where the new integrity check code is identical to the integrity check code in the first information; and
terminating an indication procedure of the capability of the terminal in a case where the new integrity check code is not identical to the integrity check code in the first information.

29-33. (canceled)

34. A communication device, comprising:
one or more processors; and
a memory that stores a computer program;
wherein the computer program, when collectively executed by the one or more processors, causes the communication device to perform the method according to claim 1.

35-37. (canceled)
